(19) United States
(12) Patent Application Publication
(10) Pub. No.: US 2026/0152174 A1
(43) Pub. Date: Jun. 4, 2026

(54) PARKING GUIDANCE TO ENHANCE VEHICLE SECURITY FOR A GEOGRAPHIC REGION

(71) Applicant: TOYOTA MOTOR ENGINEERING & MANUFACTURING NORTH AMERICA, INC., Plano, TX (US)

(72) Inventors: SEYHAN UCAR, Mountain View, CA (US); Emrah Akin Sisbot, Mountain View, CA (US); Kentaro Oguchi, Mountain View, CA (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi (JP)

(21) Appl. No.: 19/397,589

(22) Filed: Nov. 21, 2025

Related U.S. Application Data
(63) Continuation-in-part of application No. 19/175,499, filed on Apr. 10, 2025.
(63) Continuation-in-part of application No. 19/175,701, filed on Apr. 10, 2025.
Application No. 19/175,499 is a continuation-in-part of application No. 18/956,340, filed on Nov. 22, 2024.
Application No. 19/175,701 is a continuation-in-part of application No. 18/956,340, filed on Nov. 22, 2024.

(51) Int. Cl. B60W 30/06; B60W 50/14; B60W 60/00; G08G 1/14

(52) U.S. Cl. CPC B60W 30/06; B60W 50/14; B60W 60/001; G08G 1/143; G08G 1/145; B60W 2050/146; B60W 2540/215; B60W 2556/40

(57) ABSTRACT

Systems and methods are provided for enhancing vehicle security for a geographic region through intelligent and proactive parking guidance. An example method may involve: (1) obtaining resource and capability profiles of vehicles parked in a plurality of parking regions; (2) based on the obtained resource and capability profiles, determine values of a vehicle tampering deterrence metric for each of the plurality of parking regions; and (3) based on a resource and capability profile of an ego vehicle, determine the ego vehicle's potential enhancements to the values of the vehicle tampering deterrence metric for the plurality of parking regions. In some implementations, the method may further involve navigating the ego vehicle to a first parking region of the plurality of parking regions based on the determined enhancements.

### CROSS-REFERENCE TO RELATED APPLICATIONS

This application is a continuation-in-part of and claims the benefit of priority to: (1) U.S. patent application Ser. No. 19/175,499 filed on Apr. 10, 2025 and titled “VEHICLE COLLABORATION TO DETER SUSPICIOUS ACTIVITY”; and (2) U.S. patent application Ser. No. 19/175,701 filed on Apr. 10, 2025 and titled “DETECTING AND DETERRING SUSPICIOUS ACTIVITY IN RELATION TO VEHICLES,” which are both continuation-in-parts of U.S. patent application Ser. No. 18/956,340 filed on Nov. 22, 2024 and titled “VEHICLE SECURITY SYSTEM”—all of which are incorporated herein by reference in their entirety for all purposes.

### TECHNICAL FIELD

The present disclosure relates generally to vehicle security, and more particularly, some aspects relate to enhancing vehicle security for a geographic region through intelligent and proactive parking guidance.

### DESCRIPTION OF RELATED ART

Suspicious activity can be any undesirable behavior occurring in the surrounding environment or in proximity to a subject vehicle. Suspicious activity can occur relative to the physical/operating aspects or characteristics of the subject vehicle, as well as the user/owner of the subject vehicle. In some embodiments, suspicious activity may include any activity that could indicate a person may be involved in a crime or about to commit a crime. Related behaviors can include, but are not limited to, smashing car windows and taking valuable personal items, lifting the vehicle to grab valuable parts of the vehicle, or any other actions affecting or related to the subject vehicle.

Vehicles have deterrents such as video recording, audible alarms, or visual devices such as wheel locks in an effort to detect suspicious activity and to prevent harmful activities such as vehicle tampering or vehicle theft. However, vehicles are still vulnerable, and these deterrents are often inadequate. According to the National Insurance Crime Bureau, there was a 325% increase in catalytic converter theft in 2020.

### BRIEF SUMMARY OF THE DISCLOSURE

According to various embodiments of the disclosed technology a method is provided. The method may comprise: (1) obtaining resource and capability profiles of vehicles parked in a plurality of parking regions; (2) based on the obtained resource and capability profiles, determining a value of a vehicle tampering deterrence metric for each of the plurality of parking regions; and (3) based on the values of the vehicle tampering deterrence metric for the plurality of parking regions, navigating an ego vehicle to a first parking region of the plurality of parking regions.

In some embodiments of the method, navigating the ego vehicle to the first parking region may comprise displaying, on a graphical user interface (GUI) of the ego vehicle, a navigation route to the first parking region.

In certain embodiments of the method, navigating the ego vehicle to the first parking region may comprise autonomously controlling the ego vehicle to the first parking region.

In various embodiments of the method, the method may further comprise determining the ego vehicle's potential enhancements to the values of the vehicle tampering deterrence metric for the plurality of parking regions based on a resource and capability profile of the ego vehicle. Here, navigating the ego vehicle to the first parking region may be based on the ego vehicle's potential enhancements to the values of the vehicle tampering deterrence metric for the plurality of parking regions.

In some embodiments of the method, the method may further comprise displaying, on a GUI of the ego vehicle, the values of the vehicle tampering deterrence metric for the plurality of parking regions overlaid on a map representing a geographic region encompassing the plurality of parking regions. In some of such embodiments, navigating the ego vehicle to the first parking region may be responsive to an occupant of the ego vehicle selecting the first parking region on the GUI displaying the values of the vehicle tampering deterrence metric for the plurality of parking regions. In various embodiments, the method may further comprise: (a) determining the ego vehicle's potential enhancements to the values of the vehicle tampering deterrence metric for the plurality of parking regions based on a resource and capability profile of the ego vehicle; and (b) displaying the enhancements on the GUI. In certain of such embodiments, navigating the ego vehicle to the first parking region may be responsive to an occupant of the ego vehicle selecting the first parking region on the GUI displaying the enhancements.

In certain embodiments of the method, the method may further comprise displaying, on a GUI of the ego vehicle, an audio-visual recreation of at least one collaborative vehicle tampering deterrence strategy that the ego vehicle would enable by parking in the first parking region. In some of such embodiments, the audio-visual recreation of the at least one collaborative vehicle tampering deterrence strategy may comprise at least one of: (a) an audio-visual recreation of multiple vehicles in the first parking region sounding alarms in a sequence; (b) an audio-visual recreation of one vehicle in the first parking region displaying video of suspicious activity in the first parking region while another vehicle in the first parking region plays audio of the suspicious activity; (c) an audio-visual recreation of multiple vehicles in the first parking region moving autonomously in a pattern to deter the suspicious activity; (d) an audio-visual recreation of one vehicle in the first parking region illuminating the first parking region while one or more other vehicles in the first parking region move autonomously to the suspicious activity; (e) an audio-visual recreation of one or more vehicles in the first parking region recording the suspicious activity and transmitting the recorded suspicious activity to another vehicle in the first parking region which analyzes the recorded suspicious activity to determine a collaborative vehicle tampering deterrence strategy; or (f) an audio-visual recreation of multiple vehicles sequentially recording, based on their relative positions within the first parking region, a suspicious individual as the suspicious individual moves through the first parking region. In various embodiments, a respective audio-visual recreation may depict a visual representation of the ego vehicle participating in the respective audio-visual recreation.

In some embodiments of the method, the resource and capability profile for a respective vehicle may comprise at least one of: (i) sensor resources of the respective vehicle; (ii) processing resources of the respective vehicle; (iii) memory resources of the respective vehicle; (iv) wireless communication resources of the respective vehicle; (v) audio-visual output capabilities of the respective vehicle; or (vi) autonomous driving capabilities of the respective vehicle.

In certain embodiments of the method, the method may further comprise identifying the plurality of parking regions as parking regions with at least one available parking spot.

In various embodiments of the method, the value of the vehicle tampering deterrence metric for a respective parking region may quantify at least one of: (i) a number of vehicles with vehicle tampering deterrence features in the respective parking region; (ii) a number of vehicles capable of contributing to at least one collaborative vehicle tampering deterrence strategy in the respective parking region; (iii) a number of unique collaborative vehicle tampering deterrence strategies that can be implemented by vehicles parked in the respective parking region; or (iv) resources and capabilities of vehicles parked in the respective parking region which can contribute to at least one collaborative vehicle tampering deterrence strategy.

In some embodiments of the method, the first parking region may comprise a parking lot or a region of the parking lot.

In various embodiments of the presently disclosed technology, an ego vehicle is provided. The ego vehicle may comprise: (1) a graphical user interface (GUI); (2) one or more processors; and (3) memory storing machine-readable instructions that, when executed by the one or more processors, cause the ego vehicle to display, on the GUI, at least one of: (a) values of a collaborative vehicle tampering deterrence strategy metric for a plurality of parking regions overlaid on a map representing a geographic region encompassing the plurality of parking regions; or (b) the ego vehicle's potential enhancements to the values of the collaborative vehicle tampering deterrence strategy metric for the plurality of parking regions. The machine-readable instructions may comprise further instructions that, when executed by the one or more processors, cause the ego vehicle to navigate the ego vehicle to the first parking region responsive to a user input selecting a first parking region of the plurality of parking regions.

In some embodiments of the ego vehicle, the user input may comprise an occupant of the vehicle touching the GUI proximate a region of the GUI which displays the first parking region on the map.

In certain embodiments of the method, the machine-readable instructions may comprise further instructions that, when executed by the one or more processors, cause the ego vehicle to participate in a collaborative vehicle tampering deterrence strategy to deter suspicious activity in the first parking region after parking in the first parking region.

In various embodiments of the presently disclosed technology, a system is provided. The system may comprise one or more processors and memory storing machine-readable instructions that, when executed by the one or more processors, cause the system to: (1) obtain resource and capability profiles of vehicles parked in a plurality of parking regions; (2) based on the obtained resource and capability profiles, determine values of a vehicle tampering deterrence metric for each of the plurality of parking regions; (3) based on a resource and capability profile of an ego vehicle, determine the ego vehicle's potential enhancements to the values of the vehicle tampering deterrence metric for the plurality of parking regions; and (4) display, on a graphical user interface (GUI) of the ego vehicle, the determined enhancements overlaid on a map of a geographic region encompassing the plurality of parking regions.

In some embodiments of the system, the machine-readable instructions may comprise further instructions that, when executed by the one or more processors, cause the system to display, on the GUI, a navigation route to a first parking region of the plurality of parking regions.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example of an all-wheel drive hybrid vehicle with which embodiments of the systems and methods disclosed herein may be implemented.

FIG. 3A illustrates an example architecture for detecting a potential threat in a vicinity of an ego vehicle and performing a deterrence action in response to the detection, in accordance with one embodiment of the systems and methods described herein.

FIG. 3B illustrates an example implementation of a storage system, in accordance with one embodiment of the systems and methods described herein.

FIGS. 4-8 illustrate example implementations of detecting a potential threat in a vicinity of an ego vehicle and performing a deterrence action in response to the detection, in accordance with some embodiments of the systems and methods described herein, which may be implemented in conjunction with the example architecture illustrated in FIG. 3A. In FIG. 8, one or more neighboring vehicles are deployed to perform a deterrence action.

FIG. 9 is a flowchart summarizing the steps of detecting a potential threat in a vicinity of an ego vehicle and performing a deterrence action in response to the detection.

FIG. 10 is a flowchart summarizing the steps of detecting a potential threat in a vicinity of an ego vehicle and deploying one or more neighboring vehicles to perform a deterrence action in response to the detection.

FIG. 11 illustrates an example implementation of a collaborative deterrence system, in accordance with various embodiments of the presently disclosed technology.

FIG. 12 illustrates an example method that may be performed by a collaborative deterrence system to deter suspicious activity in relation to vehicles, in accordance with various embodiments of the presently disclosed technology.

FIG. 13 illustrates an example natural language processing-based method that may be performed by a monitoring and deterrence system to determine individuals are acting suspiciously in relation to vehicles, in accordance with various embodiments of the presently disclosed technology.

FIG. 14 depicts a first example collaborative deterrence strategy, in accordance with various embodiments of the presently disclosed technology.

FIG. 15 depicts a second example collaborative deterrence strategy, in accordance with various embodiments of the presently disclosed technology.

FIG. 16 depicts a third example collaborative deterrence strategy, in accordance with various embodiments of the presently disclosed technology.

FIG. 17 depicts a fourth example collaborative deterrence strategy, in accordance with various embodiments of the presently disclosed technology.

FIG. 18 depicts a fifth example collaborative deterrence strategy, in accordance with various embodiments of the presently disclosed technology.

FIG. 19 illustrates an example method that may be performed by a collaborative deterrence system to navigate an ego vehicle to a parking region to improve vehicle tampering deterrence capabilities at the parking region, in accordance with various embodiments of the presently disclosed technology.

FIG. 20 illustrates an example method that may be performed by a collaborative deterrence system to visualize, for an occupant of an ego vehicle, the ego vehicle's potential enhancements to vehicle tampering deterrence capabilities for different parking regions, in accordance with various embodiments of the presently disclosed technology.

FIG. 21 illustrates an example method that may be performed by an ego vehicle to display audio-visual recreations of collaborative vehicle tampering deterrence strategies that the ego vehicle would enable in a parking region, in accordance with various embodiments of the presently disclosed technology.

FIGS. 22A-22D illustrate example systems and methods for enhancing vehicle security for a geographic region through intelligent and proactive parking selection guidance, in accordance with various embodiments of the presently disclosed technology.

FIG. 23 illustrates an example representation of how intruders may learn to hinder a collaborative vehicle tampering deterrence strategy that has been implemented frequently.

FIG. 24 illustrates an example method that may be performed by a collaborative deterrence system to navigate an ego vehicle to a parking region to enhance the diversity of collaborative vehicle tampering deterrence strategies that can be implemented in the parking region, in accordance with various embodiments of the presently disclosed technology.

FIG. 25 illustrates an example method that may be performed by a collaborative deterrence system to visualize, for an occupant of an ego vehicle, the ego vehicle's potential enhancements to the diversity of collaborative vehicle tampering deterrence capabilities for different parking regions, in accordance with various embodiments of the presently disclosed technology.

FIG. 26 illustrates an example method that may be performed by a collaborative deterrence system to display audio-visual recreations of collaborative vehicle tampering deterrence strategies that an ego vehicle would enable in a parking region, in accordance with various embodiments of the presently disclosed technology.

FIGS. 27A-27B illustrate example systems and methods for enhancing the diversity of collaborative vehicle tampering deterrence strategies that can be implemented in a geographic region through intelligent and proactive parking selection guidance, in accordance with various embodiments of the presently disclosed technology.

FIG. 28 depicts an example flowchart illustrating how an addition of an ego vehicle with a particular resource and capability profile can enhance a value of a collaborative vehicle tampering deterrence strategy diversity metric for a parking region, in accordance with various embodiments of the presently disclosed technology.

FIG. 29 is an example computing component that may be used to implement various features of embodiments described in the present disclosure.

The figures are not exhaustive and do not limit the present disclosure to the precise form disclosed.

### DETAILED DESCRIPTION

A deterrence system of an ego vehicle may be implemented to provide a proactive and intelligent approach to improve safety of the ego vehicle as well as for neighboring vehicles and surroundings. The deterrence system may obtain sensor data from one or more sensors. The sensor data may include characteristics of a potential threat, which may include a person, another vehicle, an animal, or other being or object. The characteristics may include navigation characteristics such as relative position, relative velocity, relative heading, and/or relative acceleration of the potential threat with respect to the ego vehicle. The characteristics may include sensory characteristics of the potential threat such as visual, audio, and/or olfactory characteristics. The sensory characteristics may include additional objects associated with the potential threat such as weapons. In some embodiments, the characteristics may be inferred if not directly obtained or measured. In some embodiments, the characteristics may be inferred using object detection and/or a neural network, such as a convolutional neural network (CNN) and transformer architecture. In some embodiments, the sensor data may include characteristics of the ego vehicle itself.

Based on an evaluation of the sensor data, the deterrence system may activate certain features or augment existing features such as media (e.g., video) recording features, upon detecting a potential threat. The deterrence system may infer a type, classification, or category (hereinafter “type”) of the potential threat, a degree of severity of the potential threat, or a probability that the potential threat is an actual threat based on the sensor data and/or any recorded data. Example types of the potential threat may include a person, an animal, another vehicle, or a structure such as a collapsing structure. The deterrence system determines and implements a deterrence action based on any one or any combination of the inferred type of the potential threat, the degree of severity of the potential threat, the probability that the potential threat is an actual threat, or the sensor data. In some embodiments, determining the deterrence action is based on a lookup table, an artificial intelligence (AI) component such as a generative AI component, or a machine learning component.

In some embodiments, the deterrence action includes outputting an alarm or an audio output. The alarm or audio output may be set at a fixed or varying volume, speed, frequency, and/or other characteristic. The audio output may include an indication of a navigation or sensory characteristic of the potential threat, a command, and/or a warning of a further deterrence action if the potential threat fails to comply with the command. One example of the audio output may include, “Person in the hoodie, move away from the vehicle and put down the weapon or else authorities will be called!” In some embodiments, the deterrence action may, additionally or alternatively, include a textual output.

In some embodiments, the deterrence action includes outputting a warning to one or more neighboring vehicles regarding the potential threat. For example, the ego vehicle may be part of a peer-to-peer network with other neighboring vehicles. An example of a peer-to-peer network is Vehicular Micro Cloud. The ego vehicle may communicate with the other neighboring vehicles via Vehicle-to-Vehicle (V2V) communications. The communication may be via a remote server over Vehicle-to-Network (V2N). The remote server may generate deterrence strategies and/or communicate with the neighboring vehicles. In some embodiments, the communication with the neighboring vehicles may include a request for assistance or an indication of the potential threat. For example, the neighboring vehicles may not have been able to detect the potential threat yet, but may be informed ahead of time regarding the potential threat. Likewise, the ego vehicle may also be configured to receive communications from one or more neighboring vehicles regarding a potential threat.

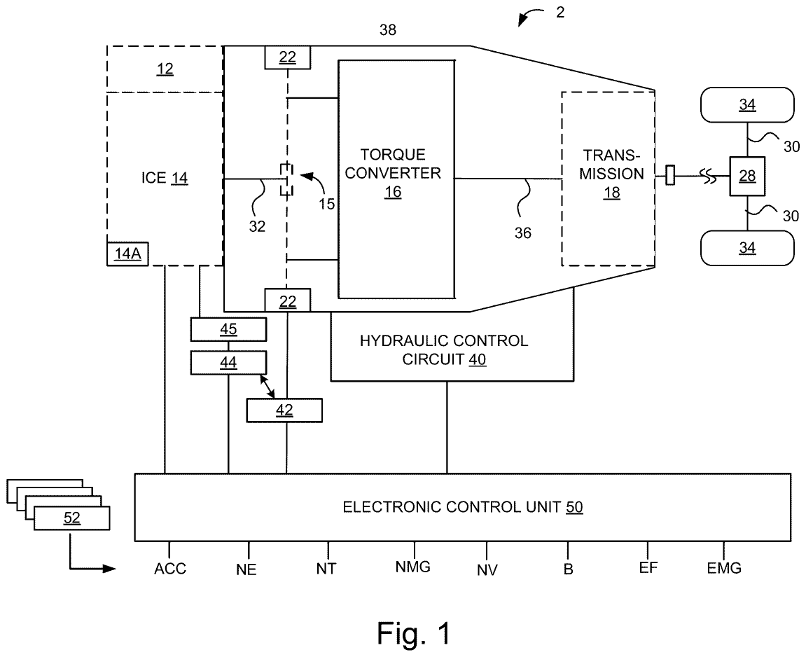

The systems and methods disclosed herein may be implemented with any of a number of different ego vehicles and ego vehicle types. For example, the systems and methods disclosed herein may be used with automobiles, trucks, motorcycles, recreational vehicles and other like on-or off-road vehicles. In addition, the principles disclosed herein may also extend to other vehicle types as well. An example hybrid electric vehicle (HEV) in which embodiments of the disclosed technology may be implemented as an ego vehicle and is illustrated in FIG. 1. Although the example described with reference to FIG. 1 is a hybrid type of ego vehicle, the systems and methods for driver fitness assessment can be implemented in other types of ego vehicles including gasoline-or diesel-powered vehicles, fuel-cell vehicles, electric vehicles, or other vehicles.

FIG. 1 illustrates a drive system of an ego vehicle 2 that may include an internal combustion engine 14 and one or more motors 22 (e.g., electric motors, which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, ego vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, ego vehicle 2 relies on the motive force generated at least by internal combustion engine 14, and a clutch 15 may be included to engage engine 14. In the EV travel mode, ego vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in ego vehicle 2 and is powered electrically via a battery 44. Battery 44 may be implemented as one or more batteries or other power storage devices including, for example, lead-acid batteries, nickel-metal hydride batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit 40. When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, ego vehicle 2 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50 execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in ego vehicle 2. For example, electronic control unit 50 may receive signals that indicate ego vehicle operating conditions or characteristics, or signals that can be used to derive ego vehicle operating conditions or characteristics. These may include, but are not limited to accelerator operation amount, ACC, a revolution speed, NE, of internal combustion engine 14 (engine RPM), a rotational speed, NMG, of the motor 22 (motor rotational speed), and vehicle speed, NV. These may also include torque converter 16 output, NT (e.g., output amps indicative of motor output), brake operation amount/pressure, B, battery SOC (i.e., the charged amount for battery 44 detected by an SOC sensor). Accordingly, ego vehicle 2 can include a plurality of sensors 52 that can be used to detect various conditions internal or external to the vehicle and provide sensed conditions to electronic control unit 50 (which, again, may be implemented as one or a plurality of individual control circuits). In one embodiment, sensors 52 may be included to detect one or more conditions directly or indirectly such as, for example, fuel efficiency, EF, motor efficiency, EMG, hybrid (internal combustion engine 14+cooling system 12) efficiency, acceleration, ACC, etc. In some embodiments, sensors 52 may detect navigation characteristics of the ego vehicle 2 or of a potential threat, such as another vehicle, pedestrian, animal, or other object. Here, navigation characteristics may include an absolute position, an absolute velocity, an absolute heading, or an absolute acceleration of the ego vehicle 2 or of the obstacle. The navigation characteristics may also include a relative position, a relative velocity, a relative heading, or a relative acceleration of the ego vehicle 2 with respect to the potential threat.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

As evident, sensors 52 may be included to detect not only vehicle conditions but also to detect external conditions, such as of the potential threat, as well. Sensors that might be used to detect external conditions can include, for example, sonar, radar, lidar or other vehicle proximity sensors, and cameras or other image sensors. Image sensors can be used to detect, for example, objects such as traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The sensors 52 may be within an interior or on an exterior of the ego vehicle 2. The sensors 52 may also include capturing sensors, which capture sensor data within the ego vehicle 2 or within surroundings of the ego vehicle 2. In some embodiments, additional sensors may not be directly connected to the ego vehicle 2, but rather, may be located on a different entity, such as a drone or a stationary landmark such as a traffic light.

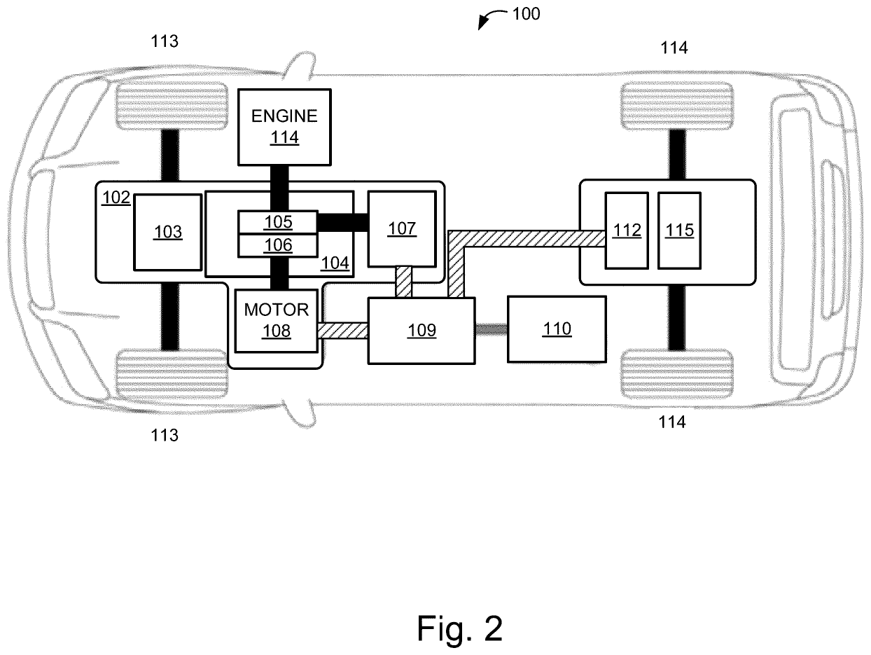

FIG. 2 is another example of an ego vehicle with which systems and methods for assessing occupant fitness can be implemented. The example illustrated in FIG. 2 is also that of a hybrid vehicle drive system of a vehicle 100 that may also include an engine 114 (e.g., internal combustion engine 14) and one or more electric motors 108, 112 (e.g., motors 22) as sources of motive power. In this example, a hybrid transaxle assembly 102 includes front differential 103, a compound gear unit 104, a motor 108, and a generator 107. Compound gear unit 104 includes a power split planetary gear unit 105 and a motor speed reduction planetary gear unit 106. This example vehicle also includes front and rear drive motors 108, 112, an inverter with converter assembly 109, battery 110 (which may include multiple batteries), and a rear differential 115. Hybrid transaxle assembly 102 enables power from engine 101, motor 108, or both to be applied to front wheels 113 via front differential 103.

Inverter with converter assembly 109 inverts DC power from battery 110 to create AC power to drive AC motors 108, 112. In embodiments where motors 108, 112 are DC motors, no inverter is required. Inverter with converter assembly 109 also accepts power from generator 107 (e.g., during engine charging) and uses this power to charge battery 110.

The examples of FIGS. 1 and 2 are provided for illustration purposes only as examples of vehicle systems with which embodiments of the disclosed technology may be implemented. One of ordinary skill in the art reading this description will understand how the disclosed embodiments can be implemented with vehicle platforms.

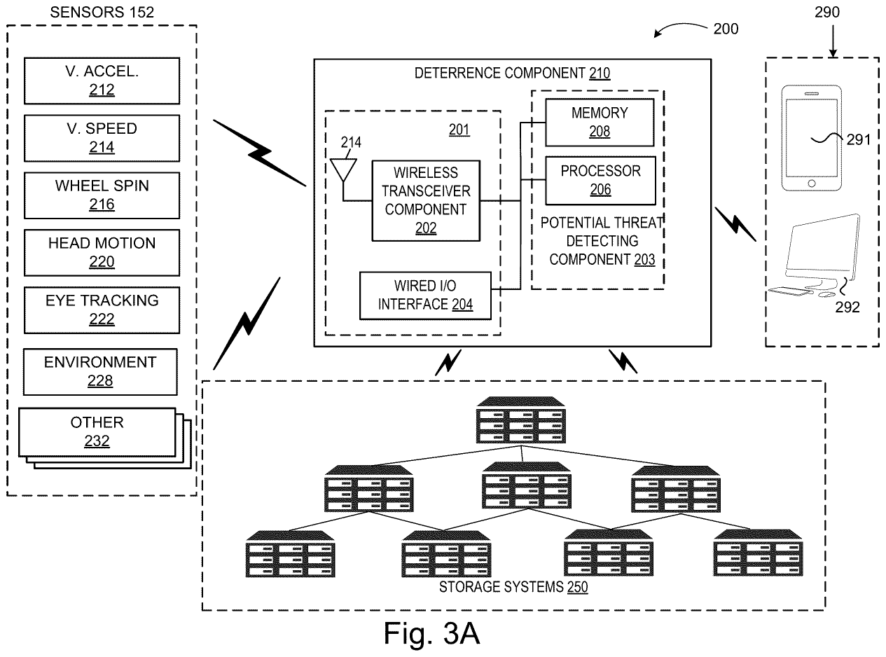

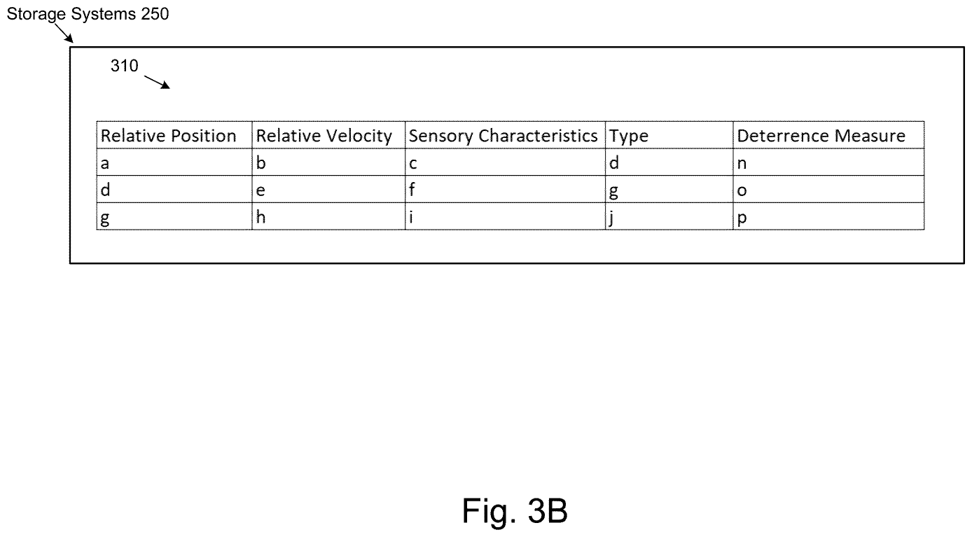

FIG. 3A illustrates an example architecture for adaptively and selectively implementing a deterrence action, based on sensor data detected at least in part by sensors 52 illustrated in FIG. 1, in accordance with one embodiment of the systems and methods described herein. Referring now to FIG. 3A, in this example, deterrence system 200 includes a deterrence component 210, which selectively activates or deactivates certain features of the ego vehicle 2, implements actions of the ego vehicle 2 or actions directed towards or controlling a potential threat, or other neighboring vehicle within a same network as the ego vehicle 2. These actions may include outputting an alarm or generating an audio output directed to the potential threat or a neighboring vehicle within a same network as the ego vehicle 2, to eliminate or mitigate the potential threat. Deterrence component 210 can be implemented as an ECU or as part of an ECU such as, for example electronic control unit 50. In other embodiments, deterrence component 210 can be implemented independently of the ECU. Deterrence component 210 in this example includes a communication component 201, and a potential threat detecting component 203 (including a processor 206 and memory 208 in this example). Components of deterrence component 210 are illustrated as communicating with each other via a data bus, although other communication in interfaces can be included.

The deterrence system 200 may include a plurality of sensors 152, one or more storage systems 250, and one or more other devices 290 which may be external to or internally located within the ego vehicle 2. In some embodiments, the one or more other devices 290 include one or more different computing or mobiles devices 291 and 292, and may be configured to receive a subset (e.g., a portion or all of) outputs from the deterrence component 210, either in real-time or in a delayed manner via V2N communication. Sensors 152, storage systems 250, and one or more other devices 290 can communicate with the deterrence component 210 via a wired or wireless communication interface. Although sensors 152, storage systems 250 and one or more other devices 290 are depicted as communicating with deterrence component 210, they can also communicate with each other as well as with other vehicle systems. In some embodiments, the one or more other devices 290 include one or more different computing or mobiles devices 291 and 292, and may be configured to receive a subset (e.g., a portion or all of) outputs from the deterrence component 210, either in real-time or in a delayed manner via V2N communication.

The potential threat detecting component 203 identifies a potential threat within a vicinity of the ego vehicle 2 and identifies or infers characteristics of the potential threat. A vicinity may refer to a particular radius of detection from the ego vehicle 2, and/or a detection range of sensors (e.g., the sensors 152). The potential threat detecting component 203 may include or be associated with one or more neural networks such as CNNs and/or transformers which may assist in inference of the characteristics of the potential threat. The potential threat detecting component 203 may identify one or more navigation characteristics such as a position, a velocity, a heading, or an acceleration of the potential threat, in absolute coordinates and/or relative coordinates with respect to the ego vehicle 2. The navigation characteristics may, additionally or alternatively, include historical navigation characteristics or time-series navigation characteristics such as a distance travelled within a previous interval of time, a trajectory, a frequency, a timing or rhythm, a pattern of movement, and/or a degree of erraticism of movement the of the potential threat. Examples of frequency may include a number or rate of repeated movements. The potential threat detecting component 203 may also identify one or more sensory characteristics such as visual, audio, and/or olfactory characteristics of the potential threat. For example, the audio and/or olfactory characteristics of the potential threat may include sounds and/or smells outputted from the potential threat. Visual characteristics may include, for a person, facial expressions, postures, body language, clothing (e.g. hoodie, mask), grooming such as hairstyle and makeup, overall appearance (e.g., degree of neatness), demeanor (e.g., degree of nervousness) and/or general characteristics such as age or gender.

In some embodiments, the potential threat detecting component 203 infers one or more attributes of the potential threat, which may include a type of the potential threat, a degree of severity of the potential threat, and/or a probability that the potential threat represents an actual threat. For example, the potential threat detecting component 203 may infer a higher degree of severity and/or a higher probability if the potential threat is moving towards the ego vehicle 2 faster and/or is brandishing a weapon. The deterrence component 210 determines and implements a deterrence action based on the sensor data captured or inferred by the potential threat detecting component 203 and/or based on the inferred attributes by the potential threat detecting component 203. In some embodiments, the deterrence action may include an output of an alarm and/or generating of an audio output. In some embodiments, the audio output may include a siren sound or a mimicked siren sound to create an impression that authorities are approaching nearby. The audio output may include an identification of the potential threat including one or more characteristics of the potential threat, a command, and/or a warning of an additional deterrence action in an event that the command is not complied with. An example audio output may be, “Person wearing a hoodie, step away from the vehicle and put down your weapon or else authorities will be dispatched.” In some embodiments, a tone, volume, speed, or other characteristics of the alarm and/or audio output may vary depending on any of the characteristics and/or attributes. For example, a potential threat of a high degree of severity and/or a high probability of representing an actual threat may result in a more urgent or serious tone, a higher volume, and/or a higher speed of the audio message. In some embodiments, the deterrence component 210 determines and implements a plurality of deterrence actions until the potential threat has been mitigated to below a threshold severity level. In some embodiments, the plurality of deterrence actions may be carried out sequentially or in a random order. In some embodiments, the plurality of deterrence actions may include progressively or iteratively increasing an urgency level of the deterrence actions if the potential threat remains unmitigated.

In some embodiments, the deterrence component 210 may recruit and deploy one or more neighboring vehicles to implement the deterrence actions. Deploying may include intelligently selecting one or more particular neighboring vehicles, transmitting a command to the one or more particular neighboring vehicles and/or otherwise controlling the one or more particular neighboring vehicles to implement the deterrence actions. The one or more neighboring vehicles may be stationary at the time of selection. In some embodiments, the implementation of the deterrence actions may be collaborated or coordinated among the ego vehicle 2 and the one or more neighboring vehicles.

The deterrence component 210 may intelligently select one or more neighboring vehicles to generate an audio output such as a mimicked siren sound. In some embodiments, the deterrence component 210 may configure one of more parameters of the audio output including a volume, a pitch, a timing, a directionality, and/or intervals between each audio output instance corresponding to a siren activation. In some embodiments, the deterrence component 210 may configure a volume of the siren sound to gradually increase over time in order to simulate a source of the siren sound getting closer. In some embodiments, the deterrence component 210 may configure a pitch to vary over time. For example, the pitch may be configured to initially be lower and gradually increase in order to provide an illusion of the source of the siren sound getting closer. In some embodiments, the deterrence component 210 may configure a timing of the siren sound. For example, the timing of the siren sound may have a slight delay between different vehicles to create an illusion that the sound is travelling from one location to another. In some embodiments, the deterrence component 210 may configure a directionality of the speakers within the vehicles to enhance perception of sound coming from multiple locations and to create an illusion of a moving sound source. In some embodiments, the deterrence component 210 may configure intervals between each siren activation on the vehicles. For example, the deterrence component 210 may start with longer intervals between the vehicles and gradually decrease the intervals to suggest that the sound is rapidly approaching.

After implementing the deterrence actions, a status of a degree of success of the deterrence actions may be transmitted to the storage systems 250, and/or to one or more AI or machine learning components to improve future determination of deterrence actions. The data structure within the storage systems 250 may be updated.

In some embodiments, as previously alluded to, determining the deterrence action is based on a data structure such as a table, as illustrated in FIG. 3B, an artificial intelligence (AI) component such as a generative AI component, or a machine learning component. As illustrated in FIG. 3B, deterrence action output data 310, including outputs of deterrence actions corresponding to different inputs (e.g., sensor data and/or inferred attributes) may be stored in storage systems 250. In some embodiments, the storage systems 250 may be part of the aforementioned remote server. The deterrence action output data 310 may be stored in a structured format, such as a tabular format (e.g., a lookup table). For example, the deterrence action output data 310 may include an output of one or more deterrence measures corresponding to a set of navigation characteristic inputs, sensory characteristic inputs, and/or inferred attributes.

Returning to FIG. 3A, sensors 152 can include, for example, sensors 52 such as those described above with reference to the example of FIG. 1. Sensors 152 can include additional sensors. In the illustrated example, sensors 152 may obtain navigation characteristics, sensory characteristics and/or other related data such as behavioral and/or interaction data of other objects external to the ego vehicle 2, and/or of occupants within the ego vehicle 2. The sensors 152 may include vehicle acceleration sensors 212, vehicle speed sensors 214, wheelspin sensors 216 (e.g., one for each steering wheel), head motion sensors 220 to detect rotational and/or translational motion of a head of a driver within the ego vehicle 2, eye tracking sensors 222 to detect eye movements of the driver, and environmental sensors 228 (e.g., to detect traffic density, speed of surrounding traffic, weather, air quality, and/or other environmental conditions). In some embodiments, sensor data from the environmental sensors 228 may affect whether or not an output from the deterrence component 210 is to be generated or displayed, and/or whether certain actions are to be implemented by the deterrence component 210. For example, if traffic density is high and/or the environment has hazy conditions, then certain actions may be less or more likely to be implemented. Additional sensors 232 can also be included as may be appropriate for a given implementation of deterrence system 200. The sensors 152 may be configured to detect and/or alert for any indications of anomalous behavior, as will be described below.

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store any information used to perform a driver fitness test, for processor 206 as well as any other suitable information. Memory 208 can be made up of one or more modules of one or more different types of memory, and may be configured to store data and other information as well as operational instructions that may be used by the processor 206.

Although the example of FIG. 3A is illustrated using processor and memory components, as described below with reference to components disclosed herein, potential collision detecting component 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up collision detecting component 203 and/or deterrence component 210.

Communication component 201 includes either or both a wireless transceiver component 202 with an associated antenna 205 and a wired I/O interface 204 with an associated hardwired data port (not illustrated). As this example illustrates, communications with deterrence component 210 can include either or both wired and wireless communication components 201. Wireless transceiver component 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 214 is coupled to wireless transceiver component 202 and is used by wireless transceiver component 202 to transmit radio signals wirelessly to wireless equipment with which it is connected and to receive radio signals as well. These RF signals can include information of almost any sort that is sent or received by deterrence component 210 to/from other entities such as sensors 152 and storage systems 250.

Wired I/O interface 204 can include a transmitter and a receiver (not shown) for hardwired communications with other devices. For example, wired I/O interface 204 can provide a hardwired interface to other components, including sensors 152 and storage systems 250. Wired I/O interface 204 can communicate with other devices using Ethernet or any of a number of other wired communication protocols whether standardized, proprietary, open, point-to-point, networked or otherwise.

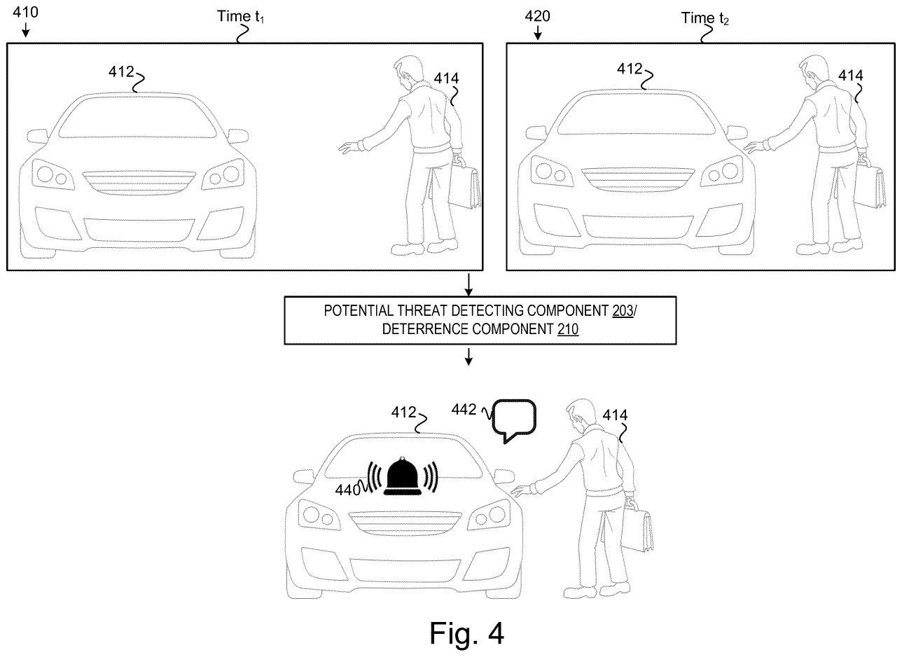

FIGS. 4-6 illustrate embodiments of the potential threat detecting component 203 and the deterrence component 210. In some embodiments, as illustrated in FIGS. 4-6, the potential threat detecting component 203 outputs an alarm or generates an output such as an audio and/or textual output. In some embodiments, the principles in FIGS. 4-6 may be applied in conjunction with FIG. 3A.

FIG. 4 illustrates an operation scenario 410 at a time t₁ and an operation scenario 420 at a time t₂ of an ego vehicle 412 and a potential threat 414, here, a person. As evident, between time t₁ and time t₂ the potential threat 414 has moved closer to the ego vehicle 412. In some embodiments, the ego vehicle 412 may be implemented as the ego vehicle 2. In some embodiments, the ego vehicle 412 may be stationary. Sensor data of the potential threat 414 and of the ego vehicle 412 between the operation scenarios 410 and 420 is obtained, captured, or inferred by the potential threat detecting component 203. The sensor data includes including navigation characteristics (e.g., relative position, relative velocity, and relative heading of the potential threat 414 relative to the ego vehicle 412) and sensory characteristics of the potential threat 414, such as the person carrying an object (e.g., a suitcase). The potential threat detecting component 203 infers one or more attributes such as a type of the potential threat 414, here, a person. The potential threat detecting component 203 may additionally or alternatively infer attributes such as a degree of severity of the potential threat 414 and/or a probability that the potential threat 414 represents an actual threat based on the sensor data.

The deterrence component 210 determines and implements one or more deterrence actions. Here, the deterrence actions may include outputting an alarm 440 and/or generating an audio output 442. Here, an example of a generated audio output 442 may identify that the potential threat 414 is a person, that the potential threat 414 is carrying a suitcase, and/or clothes that the potential threat 414 is wearing. An example of a generated audio output 442 may include, “Person wearing a long-sleeved shirt with black hair and carrying a suitcase, step away from the vehicle immediately or else authorities will be dispatched.” In other embodiments, the deterrence component 210 may implement other actions such as flashing lights, and/or textual outputs displayed visibly to the potential threat 414, analogous to the audio outputs.

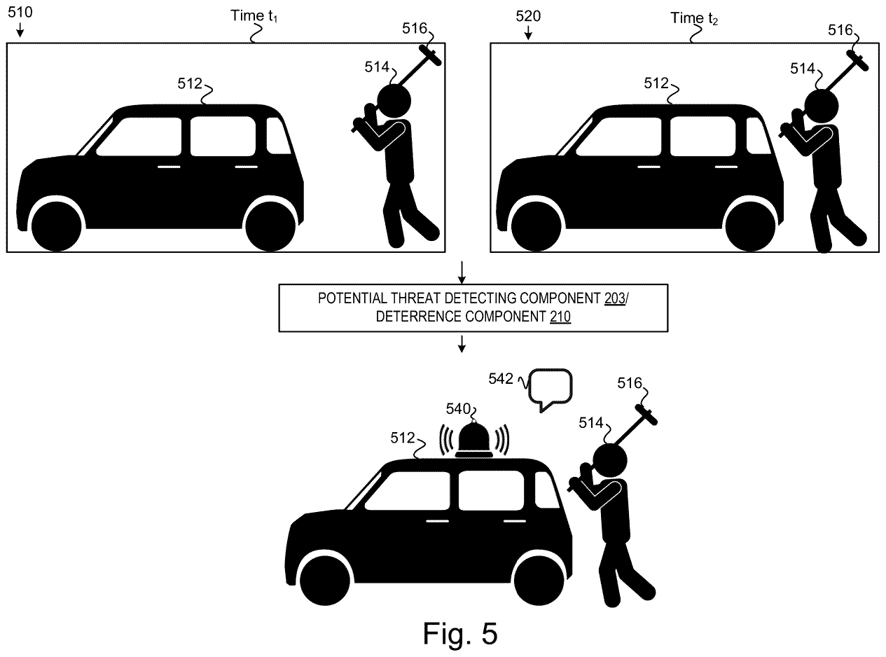

FIG. 5 illustrates an operation scenario 510 at a time t₁ and an operation scenario 520 at a time t₂ of an ego vehicle 512 and a potential threat 514, here, a person. As evident, between time t₁ and time t₂ the potential threat 514 has moved closer to the ego vehicle 512. In some embodiments, the ego vehicle 512 may be implemented as the ego vehicle 2. Sensor data of the potential threat 514 and of the ego vehicle 512 between the operation scenarios 510 and 520 is obtained, captured, or inferred by the potential threat detecting component 203. The sensor data includes including navigation characteristics (e.g., relative position, relative velocity, and relative heading of the potential threat 514 relative to the ego vehicle 512) and sensory characteristics of the potential threat 514, such as the person carrying an object (e.g., a weapon). The potential threat detecting component 203 infers one or more attributes such as a type of the potential threat 514, here, a person. The potential threat detecting component 203 may additionally or alternatively infer attributes such as a degree of severity of the potential threat 514 and/or a probability that the potential threat 514 represents an actual threat based on the sensor data.

The deterrence component 210 determines and implements one or more deterrence actions. Here, the deterrence actions may include outputting an alarm 540 and/or generating an audio output 542. Here, an example of a generated audio output 542 may identify that the potential threat 514 is a person, that the potential threat 514 is carrying a weapon, and/or clothes that the potential threat 414 is wearing. An example of a generated audio output 542 may include, “Person carrying a weapon, step away from the vehicle immediately and drop the weapon or else authorities will be dispatched.” In other embodiments, the deterrence component 210 may implement other actions such as flashing lights, and/or textual outputs displayed visibly to the potential threat 514, analogous to the audio outputs.

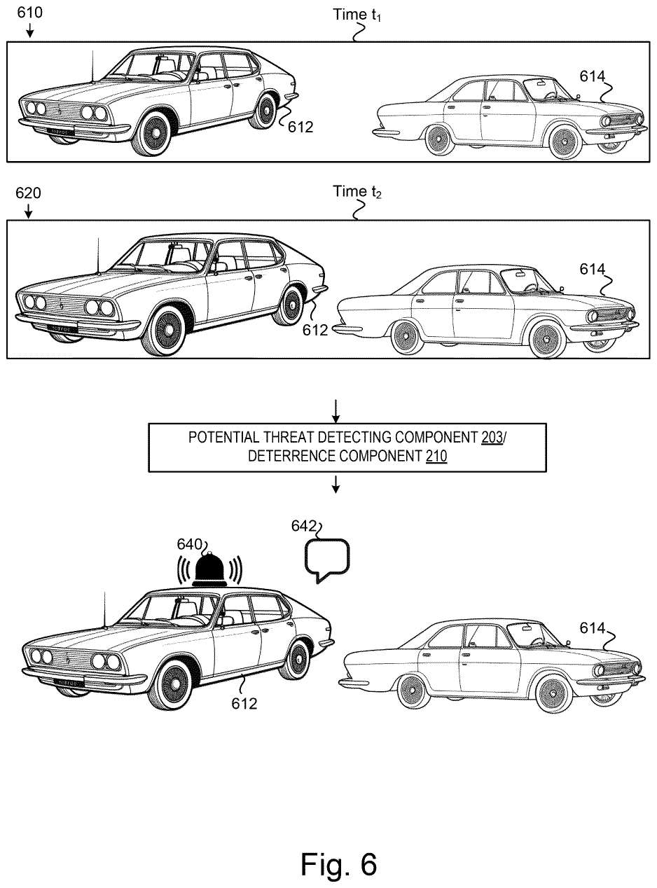

FIG. 6 illustrates an operation scenario 610 at a time t₁ and an operation scenario 620 at a time t₂ of an ego vehicle 612 and a potential threat 614, here, a different vehicle. As evident, between time t₁ and time t₂ the potential threat 614 has moved closer to the ego vehicle 612. In some embodiments, the ego vehicle 612 may be implemented as the ego vehicle 2. Sensor data of the potential threat 614 and of the ego vehicle 612 between the operation scenarios 610 and 620 is obtained, captured, or inferred by the potential threat detecting component 203. The sensor data includes including navigation characteristics (e.g., relative position, relative velocity, and relative heading of the potential threat 614 relative to the ego vehicle 612) and sensory characteristics of the potential threat 614, such as a color, a type of vehicle, a make or model, any occupants within the potential threat 614, and/or other identifying characteristics of the potential threat 614 such as license plate numbers. The potential threat detecting component 203 infers one or more attributes such as a type of the potential threat 614, here, a vehicle. The potential threat detecting component 203 may additionally or alternatively infer attributes such as a degree of severity of the potential threat 614 and/or a probability that the potential threat 614 represents an actual threat based on the sensor data.

The deterrence component 210 determines and implements one or more deterrence actions. Here, the deterrence actions may include outputting an alarm 640 and/or generating an audio output 642. Here, an example of a generated audio output 642 may identify that the potential threat 614 is a vehicle, that the potential threat 614 is backing towards the ego vehicle 612, and/or other characteristics of the potential threat 614. An example of a generated audio output 642 may include, “White sedan having a license plate number X, stop immediately.” In some embodiments, the generated audio output 642 may be directed to a communication system of the potential threat 614, for example, via V2N communications. Upon receiving the generated audio output 642, the potential threat 614 may autonomously stop to avoid a collision with the ego vehicle 612. Alternatively, an occupant such as a safety driver may manually stop the potential threat 614.

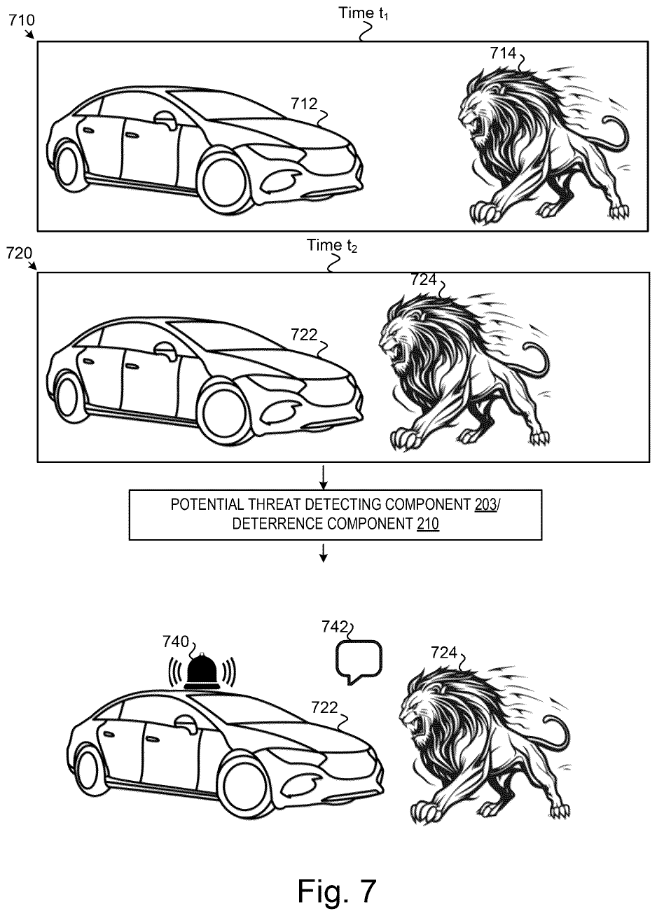

FIG. 7 illustrates an operation scenario 710 at a time t₁ and an operation scenario 720 at a time t₂ of an ego vehicle 712 and a potential threat 714, here, an animal (e.g., a bear, lion, or cat). As evident, between time t₁ and time t₂ the potential threat 714 has moved closer to the ego vehicle 712. In some embodiments, the ego vehicle 712 may be implemented as the ego vehicle 2. Sensor data of the potential threat 714 and of the ego vehicle 712 between the operation scenarios 710 and 720 is obtained, captured, or inferred by the potential threat detecting component 203. The sensor data includes including navigation characteristics (e.g., relative position, relative velocity, and relative heading of the potential threat 714 relative to the ego vehicle 612) and sensory characteristics of the potential threat 714, such as a color and/or other identifying characteristics of the potential threat 714. The potential threat detecting component 203 infers one or more attributes such as a type of the potential threat 714, here, a wild animal. The potential threat detecting component 203 may additionally or alternatively infer attributes such as a degree of severity of the potential threat 714 and/or a probability that the potential threat 714 represents an actual threat based on the sensor data.

The deterrence component 210 determines and implements one or more deterrence actions. Here, the deterrence actions may include outputting an alarm 740 and/or generating an audio output 742. Here, an example of a generated audio output 742 may include one or more warning sounds or noises that are particular adapted to scare off a particular type of animal. The generated audio output 742 may not include audible words because a wild animal would not understand the words. In some embodiments, the generated audio output 742 may include a warning message to inform other humans regarding the presence of a wild animal.

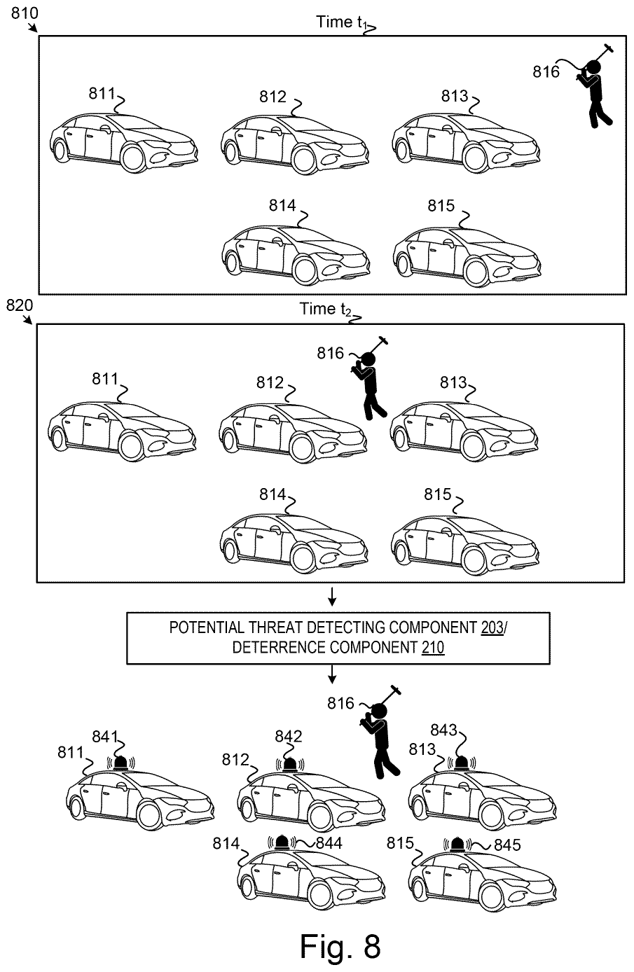

FIG. 8 illustrates an operation scenario 810 at a time t₁ and an operation scenario 820 at a time t₂ of an ego vehicle 811, neighboring vehicles 812-815, and a potential threat 816, here, a person. As evident, between time t₁ and time t₂ the potential threat 816 has moved closer towards the neighboring vehicle 812. In some embodiments, the ego vehicle 811 may be implemented as the ego vehicle 2. Sensor data of the potential threat 814 and of or near the ego vehicle 811, and the neighboring vehicles 812-815 is obtained, captured, or inferred by the potential threat detecting component 203. The sensor data may be taken at time periods between and/or including the operation scenarios 810 and 820. The sensor data includes including navigation characteristics (e.g., relative position, relative velocity, and relative heading of the potential threat 816 relative to the ego vehicle 811) and sensory characteristics of the potential threat 816, such as a color and/or other identifying characteristics of the potential threat 816. The potential threat detecting component 203 infers one or more attributes such as a type of the potential threat 816, here, a wild animal. The potential threat detecting component 203 may additionally or alternatively infer attributes such as a degree of severity of the potential threat 816 and/or a probability that the potential threat 816 represents an actual threat based on the sensor data.

The deterrence component 210 determines and implements one or more deterrence actions. Here, the deterrence actions may include outputting an alarm 841 or other audio output (hereinafter “alarm”). The alarm may mimic a voice of a siren or other warning. The deterrence actions may, additionally or alternatively, include deploying any of the one or more neighboring vehicles 812, 813, 814, and 815 to output respective alarms 842, 843, 844, and 845. For example, based on a current location of the potential threat 816 and/or a future predicted location of the potential threat 816, the deterrence actions may include deploying the one or more neighboring vehicles 812, 813, 814 and/or 815 to output a coordinated alarm to simulate an authority vehicle such as a police car getting closer toward the current location or the predicted future location. As a specific, nonlimiting example, the deterrence component 210 may deploy one or more of the neighboring vehicles 812, 813, 814 and/or 815 to gradually increase a volume of the alarm 842 over a time period. The deployment may include deploying one of the neighboring vehicles (e.g., the neighboring vehicle 812) to increase a volume of a corresponding alarm (e.g., the alarm 842) over the time period. As another specific example, the deployment may include varying volumes of the alarms 842, 843, 844, and 845 such that the alarms 842, 843, 844, and 845 have different volumes, in order to simulate approaching authority vehicles from different directions. Thus, varying of the volumes of the alarms 841, 842, 843, 844, and 845 may be performed across both space and time.

Similarly, a pitch of any of the alarms 841, 842, 843, 844, and/or 845 may be varied over time. As another example, a timing of any of the alarms 841, 842, 843, 844, and/or 845 may be staggered such that the alarms 841, 842, 843, 844, and/or 845 are triggered at different times. As another example, a directionality of any of the alarms 841, 842, 843, 844, and/or 845 (e.g., a direction to which the alarms are directed towards) may also be varied across the alarms 841, 842, 843, 844, and/or 845, and/or varied over a time period. As another example, an interval between each individual alarm triggering and/or between successive different alarms, a wavelength, and/or a period of the alarms may be varied. An initial interval between each individual alarm and/or between successive different alarms may be longer, and over time, the interval may be shorted to provide an impression that a source of the alarms is rapidly approaching.

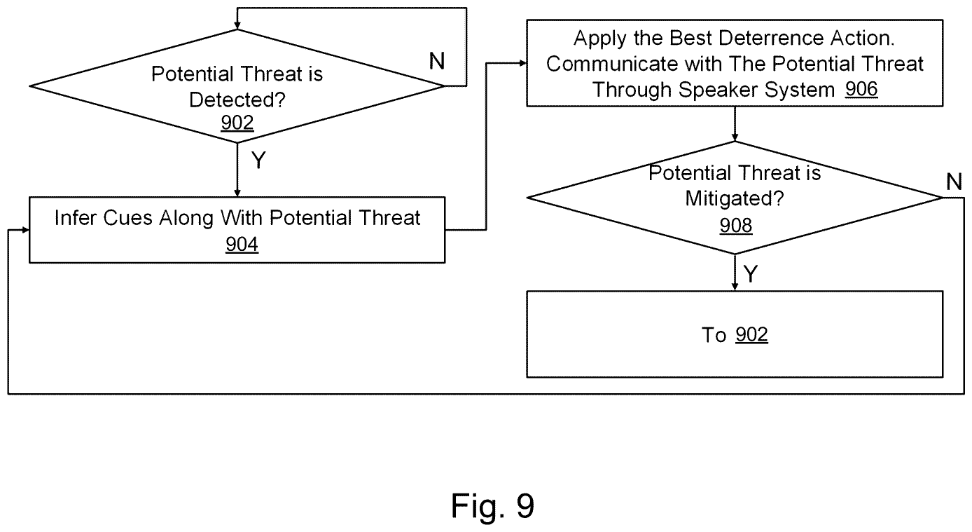

FIG. 9 is a flowchart of a method of deterrence of a potential threat, consistent with FIGS. 1-2, 3A, 3B, and 4-7. In decision 902, the potential threat detecting component 203 determines whether a potential threat has been detected from sensor data. If not, then the potential threat detecting component 203 continues to obtain or detect sensor data until a potential threat is detected. In step 904, responsive to a positive determination in decision 902, the potential threat detecting component 203 infers one or more cues associated with the detected potential threat. The one or more cues may include navigation characteristics and/or sensory characteristics. In step 906, the deterrence component 210 applies one or more deterrence actions. In some examples, the one or more deterrence actions may communicate with the potential threat via a vehicle speaker system. For example, the one or more deterrence actions may include an alarm at fixed or varying volume, frequency, and/or other alarm characteristics. The one or more deterrence actions may include an audio output or other output. In decision 908, the deterrence component 210 or the potential threat detecting component 203 determines whether the potential threat has been sufficiently mitigated (e.g., a degree of severity of the potential threat has fallen to below a threshold severity). In response to a negative determination, the deterrence component 210 returns to step 904. In response to a positive determination, the deterrence component returns to decision 902.

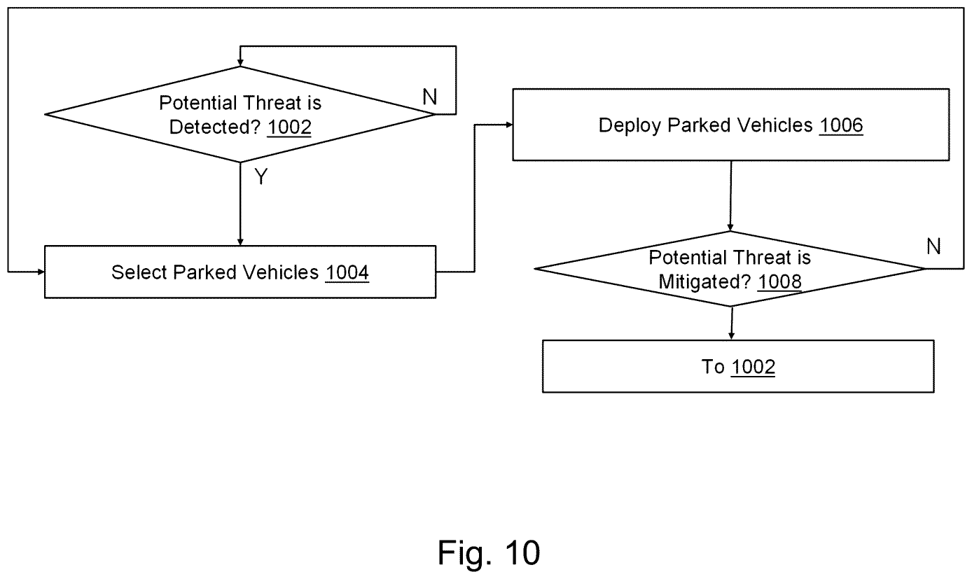

FIG. 10 is a flowchart of a method of deterrence of a potential threat, consistent with FIG. 8. In decision 1002, the potential threat detecting component 203 determines whether a potential threat has been detected from sensor data. If not, then the potential threat detecting component 203 continues to obtain or detect sensor data until a potential threat is detected. In step 1004, responsive to a positive determination in decision 1002, the potential threat detecting component 203 selects one or more neighboring vehicles to be deployed. In step 1006, the deterrence component 210 deploys any of the selected neighboring vehicles to apply one or more deterrence actions. In some examples, the one or more deterrence actions may include causing any of the selected neighboring vehicles to output an alarm that resembles a siren sound in a coordinated manner. In decision 1008, the deterrence component 210 or the potential threat detecting component 203 determines whether the potential threat has been sufficiently mitigated (e.g., a degree of severity of the potential threat has fallen to below a threshold severity). In response to a negative determination, the deterrence component 210 returns to step 1004. In response to a positive determination, the deterrence component returns to decision 1002.

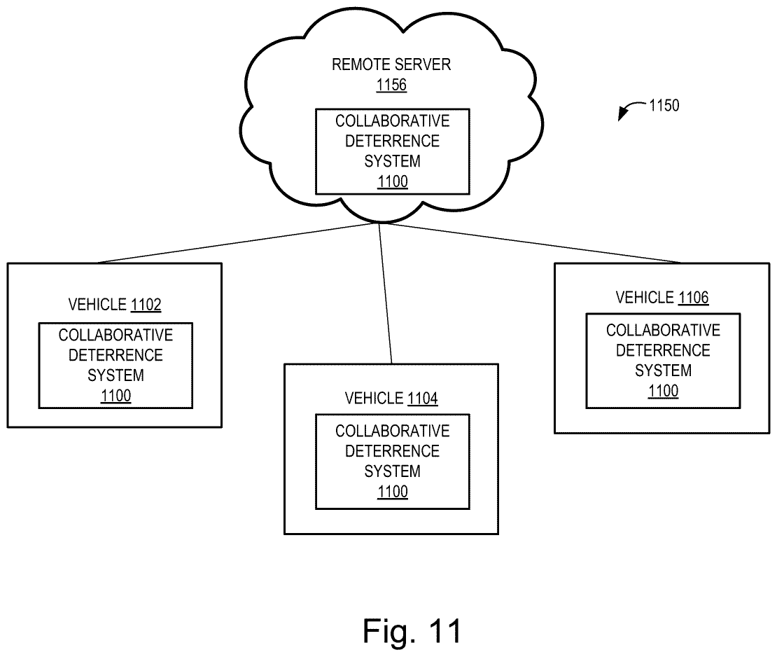

FIG. 11 illustrates an example implementation of a collaborative deterrence system 1100, in accordance with various embodiments of the presently disclosed technology. Collaborative deterrence system 1100 may be a particular implementation of deterrence system 200 from FIG. 3A.

As alluded to above, a shortcoming of many existing deterrence systems is that they operate individually without coordination. As perpetrators assess their surroundings and choose a target, in many cases vehicles will independently detect suspicious activity and respond with their own independent deterrence actions. Suspicious activity may take many different forms. Suspicious activity around a vehicle typically involves actions that appear out of place, evasive, or potentially unlawful. Individuals may loiter near a vehicle without a clear purpose, often glancing around or checking their surroundings nervously. They might try door handles, peer into windows—sometimes using a flashlight—or circle the vehicle repeatedly. Attempts to manipulate locks, use tools near windows, or remove items in a hurried or discreet manner, especially if accompanied by efforts to hide their face or avoid surveillance cameras, indicate suspicious behavior. Wearing inappropriate clothing for the weather, such as a hood on a warm day, can also be a sign of suspicious activity. In many cases, these individuals may quickly walk away or pretend to be engaged in another activity when approached. While context is important (e.g., such as delivery personnel or people waiting for rides) the combination and pattern of these behaviors can indicate potential criminal intent. Thus, suspicious activity may be detected by observing such behaviors alone or in combination in the context of the then-current situation.

As collaborative deterrence system 1100 is designed in appreciation of, collaborative deterrence can be far more effective at deterring suspicious activity than existing deterrence systems which operate independently without coordination. By sharing inferred knowledge among nearby vehicles, collaborative deterrence system 1100 can track a suspicious individual's movements across multiple vehicles and alert innocent drivers before they park in vulnerable spots. Collaborative deterrence system 1100 enables multiple vehicles (e.g., vehicles 1102, 1104 and 1106) to act in coordination, enhancing deterrence and overall vehicle safety. Additionally, if perpetrators break into a vehicle, collaborative deterrence system 1100 can continue tracking their movements, providing valuable evidence for authorities.

For example (and as described in greater detail below), vehicles inspected by suspicious individuals can use AI to generate natural language descriptions of suspicious individuals and their activities. These natural language descriptions can be shared among the vehicles, along with recorded videos and audio (e.g., conversations between suspicious individuals). Facilitated/orchestrated by collaborative deterrence system 1100, the vehicles can then coordinate collaborative deterrence actions. For example, vehicle 1102 may display recorded video of a suspicious individual on its dashboard, while vehicles 1104 and 1106 play audio of another suspicious individual. Such a collaborative deterrence strategy can reinforce that the suspicious individuals are being tracked and recorded from the start. Accordingly, collaborative deterrence system 1100/vehicles 1102-1106 can effectively come up with a collaborative deterrence strategy to protect vehicles 1102-1106 and their surroundings. This collaborative approach not only helps to prevent suspicious activities, but also enhances the overall security of vehicles and their environment.

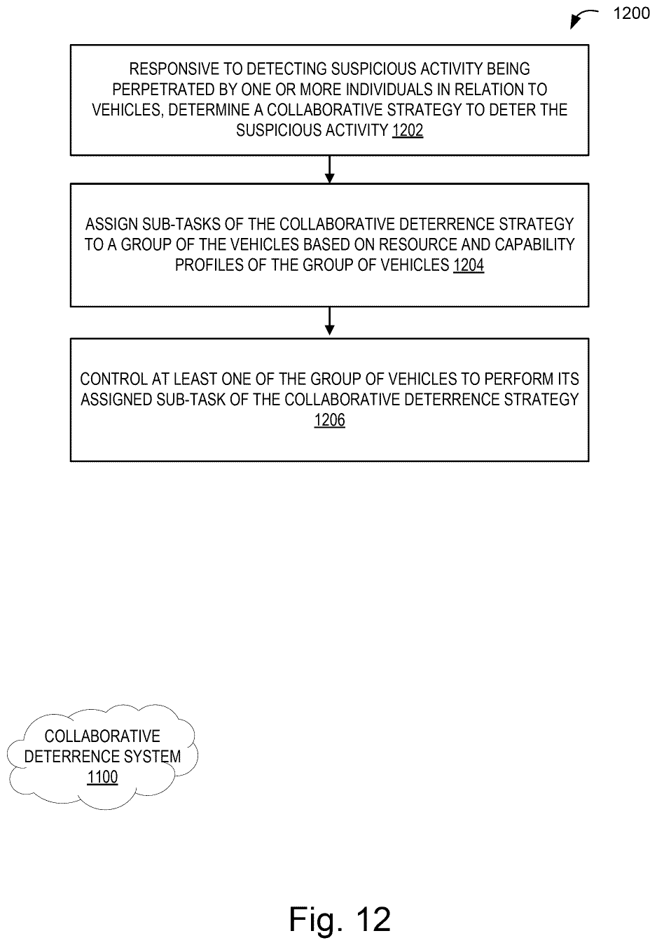

As described in greater detail in conjunction with FIG. 12, collaborative deterrence system 1100 may improve upon potential alternative designs by intelligently assigning sub-tasks of a collaborative deterrence strategy to different vehicles based on resource and capability profiles of the different vehicles. For example, collaborative deterrence system 1100 can intelligently assign sub-tasks of a collaborative deterrence strategy to vehicles 1102, 1104 and 1106 based on at least one of: (a) differences in sensor resources across vehicles 1102-1106; (b) differences in processing resources across vehicles 1102-1106; (c) differences in wireless communication resources across vehicles 1102-1106; (d) differences in audio-visual output capabilities across vehicles 1102-1106; or (e) differences in autonomous driving capabilities across vehicles 1102-1106.

As a more specific example, collaborative deterrence system 1100 may determine that vehicle 1102 has superior processing resources to vehicles 1104 and 1106. Accordingly, collaborative deterrence system 1100 may: (i) assign vehicle 1102 to further analyze activity of one or more suspicious individuals in relation to vehicles 1102-1106; and (ii) assign vehicles 1104 and 1106 to perform less processor-intensive sub-tasks of the collaborative deterrence strategy (e.g., video and audio recording, sounding an alarm, displaying video of the suspicious individuals, moving autonomously to disorient or spook the suspicious individuals, etc.). As another example, collaborative deterrence system 1100 may determine that vehicle 1102 has superior audio output capabilities (e.g., a louder speaker, a speaker with great sound/pitch modulation capabilities, a speaker that is able to play back audio of suspicious individuals, etc.) to vehicles 1104 and 1106. Accordingly, collaborative deterrence system 1100 can: (i) assign vehicle 1102 to output an audio-based deterrence action (e.g., an audio alarm or warning, playing back recorded audio of the suspicious individuals, etc.); and (ii) assign vehicles 1104 and 1106 to perform non-audio output-related sub-tasks of the collaborative deterrence strategy (e.g., video and audio recording of the suspicious individuals, analyzing video and audio recording of the suspicious individuals, displaying video of the suspicious individuals, moving autonomously to disorient or spook the suspicious individuals, etc.). In sum, by intelligently assigning sub-tasks of a collaborative deterrence strategy to different vehicles based on resource and capability profiles of the different vehicles, collaborative deterrence system 1100 can improve upon potential alternative designs which do not consider this intelligent and tailored assignment of sub-tasks.

Referring again to the architecture of FIG. 11, in some embodiments collaborative deterrence system 1100 may be implemented across a remote server 1156 and one or more vehicles, such as vehicle 1102, vehicle 1104, and vehicle 1106 (each of which may be an example of ego vehicle 2 from FIG. 1 or vehicle 100 from FIG. 2). In various implementations, vehicles 1102-1106 may be parked in a common location (e.g., a parking lot). However, in other implementations one or more of vehicles 1102-1106 may be moving.

As depicted, collaborative deterrence system 1100 may be facilitated by a remote environment 1150. In some embodiments, remove environment 1150 may comprise a cloud-based environment. In other embodiments, remote environment 1150 may comprise an edge-based environment. Such an edge-based environment can utilize various types of edge infrastructure, such as roadside/traffic infrastructure, infrastructure (e.g., a dedicated server) proximate a parking lot where vehicles 1102-1106 are parked, cellular network infrastructure, etc. In some implementations, remote environment 1150 may be a combination of a cloud-based environment and an edge-based environment.

Accordingly, collaborative deterrence system 1100 may include separate instances within one or more entities of remote environment 1150, such as remote server 1156, vehicle 1102, vehicle 1104, and vehicle 1106. In a further aspect, the entities that implement collaborative deterrence system 1100 within remote environment 1150 may vary beyond transportation-related devices and encompass roadside infrastructure elements. Thus, the set of entities that function in coordination with remote environment 1150 may be varied.

In some embodiments, vehicles 1102-1106 may form collaborative deterrence system 1100 by forming a peer-to-peer/ad-hoc network, such as a vehicular micro-cloud (VMC). In such embodiments, remote server 1150 can oversee/orchestrate the collaboration among vehicles.

In some embodiments, remote environment 1150 itself may comprise a dynamic environment that comprises VMC members that migrate into and out of a geographic area.

FIG. 12 illustrates an example method 1200 that may be performed by collaborative deterrence system 1100 to deter suspicious activity in relation to vehicles, in accordance with various embodiments of the presently disclosed technology.

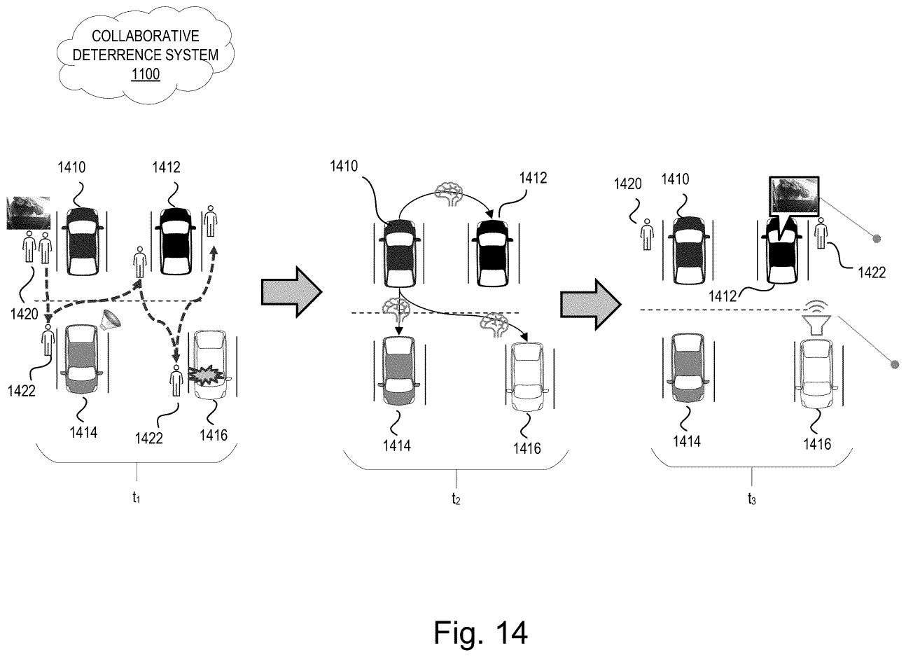

Responsive to detecting suspicious activity being perpetrated by one or more individuals in relation to vehicles, collaborative deterrence system 1100 can perform operation 1202 to determine a collaborative strategy to deter the suspicious activity. Examples of such a collaborative deterrence strategy are described in greater detail in conjunction with FIGS. 14-18.

According to some aspects, detecting the suspicious activity may be based on detecting suspicious behaviors, alone or in combination, by the one or more individuals in the context of the then-current situation. Threshold levels can be set, and the behavior can be observed according to the threshold levels. If the suspicious activity rises above a determined threshold, collaborative deterrence system 1100 may determine that the one or more individuals are acting suspiciously in relation to the vehicles.

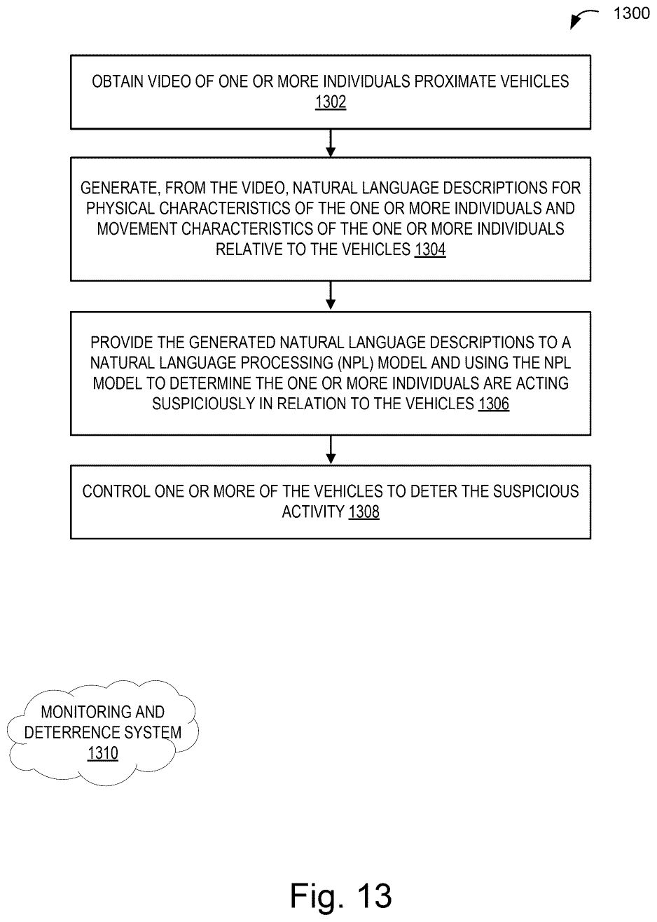

As described in greater detail in conjunction with FIG. 13, in some implementations collaborative deterrence system 1100 can detect the suspicious activity by: (1) obtaining video of the one or more individuals (e.g., from video-recording cameras of one or more of the vehicles); (2) generating, from the video, natural language descriptions for physical characteristics of the one or more individuals and movement characteristics of the one or more individuals relative to the vehicles; and (3) providing the generated natural language descriptions to a natural language processing (NPL) model and using the NPL model to determine the one or more individuals are acting suspiciously in relation to the vehicles.

After determining the collaborative deterrence strategy, collaborative deterrence system 1100 can perform operation 1204 to assign sub-tasks of the collaborative deterrence strategy to a group of the vehicles based on resource and capability profiles of the group of vehicles. For example, assigning the sub-tasks of the collaborative deterrence strategy to the group of the vehicles may be based on at least one of: (a) differences in sensor resources across the group of vehicles; (b) differences in processing resources across the group of vehicles; (c) differences in wireless communication resources across the group of vehicles; (d) differences in audio-visual output capabilities across the group of vehicles; or (e) differences in autonomous driving capabilities across the group of vehicles.

As an example, the group of vehicles may comprise at least a first vehicle and a second vehicle and assigning the sub-tasks of the collaborative deterrence strategy to the first and second vehicles may comprise: (i) determining the first vehicle has superior processing resources to the second vehicle; (ii) assigning the first vehicle to further analyze the activity of the one or more individuals in relation to the vehicles; and (iii) assigning the second vehicle to perform a less processor-intensive sub-task of the collaborative deterrence strategy (e.g., recording further audio or video of the one or more individuals, sounding a warning or alarm, playing back recorded audio of the one or more individuals, displaying recorded video of the one or more individuals, etc.).

As a second example, collaborative deterrence system 1100 may: (i) determine the first vehicle has superior audio output capabilities (e.g., a louder speaker or alarm, a speaker with greater sound/pitch modulation capabilities, a speaker capable of playing back audio of the one or more individuals, etc.) to the second vehicle; (ii) assign the first vehicle to output an audio-based deterrence action (e.g., sounding an audio alarm or warning, playing recorded audio of the suspicious individuals, etc.); and (iii) assign the second vehicle to perform a non-audio output-related sub-task of the collaborative deterrence strategy (e.g., recording further audio or video of the one or more individuals, analyzing the foregoing recorded audio or video, displaying recorded video of the one or more individuals, moving autonomously to spook or disorient the one or more individuals, etc.).

As a third example, collaborative deterrence system 1100 may: (i) determine the first vehicle has a superior visual display (e.g., a larger visual display, a higher resolution visual display, etc.) to the second vehicle; (ii) assign the first vehicle to display video of the one or more individuals on its superior visual display; and (iii) assign the second vehicle to perform a non-visual output-related sub-task of the collaborative deterrence strategy (e.g., recording further audio or video of the one or more individuals, analyzing the foregoing recorded audio or video, sounding an audio alarm or warning, playing recorded audio of the suspicious individuals, moving autonomously to spook or disorient the one or more individuals, etc.).

As a fourth example, collaborative deterrence system 1100 may: (i) determine the first vehicle has superior autonomous driving capabilities (e.g., superior fully or semi-autonomous driving features, superior parking assist features, a superior advanced driver-assistance system (ADAS), etc.) to the second vehicle; (ii) assign the first vehicle to move autonomously to deter the suspicious activity; and (iii) assign the second vehicle to perform a non-autonomous driving-related sub-task of the collaborative deterrence strategy (e.g., recording further audio or video of the one or more individuals, analyzing the foregoing recorded audio or video, sounding an audio alarm or warning, playing recorded audio of the suspicious individuals, playing recorded video of the suspicious individuals, etc.).

In some implementations, collaborative deterrence system 1100 may also consider detected positional relationships between the one or more individuals and respective vehicles of the group of vehicles when intelligently assigning the sub-tasks of the collaborative deterrence strategy to the group of the vehicles. For example, collaborative deterrence system 1100 may assign the sub-tasks based on detected location and attentional direction of the one or more individuals with respect to respective vehicles of the group of vehicles. As a more specific example (and where the group of vehicles comprises at least a first vehicle and a second vehicle), collaborative deterrence system 1100 may: (i) determine that at least one of the one or more individuals is gazing into the first vehicle; (ii) assign the first vehicle to display video of the one or more individuals on a visual display within the first vehicle; and (iii) assigning the second vehicle to perform a non-visual output-related sub-task of the collaborative deterrence strategy.

After assigning the sub-tasks of the collaborative deterrence strategy to the group of vehicles, collaborative deterrence system 1100 can perform operation 1206 to control at least one of the group of vehicles to perform its assigned sub-task.

While not directly depicted in FIG. 12, in some implementations collaborative deterrence system 1100 can determine a collaborative strategy to further monitor the suspicious activity as well. Accordingly, collaborative deterrence system 1100 can assign sub-tasks of the collaborative monitoring strategy to the group of vehicles based on: (a) the resource and capability profiles of the group of vehicles; and (b) positional relationships between the one or more individuals and respective vehicles of the group of vehicles (or more specifically, positional relationships between the one or more individuals and respective sensors of the group of vehicles). This may involve assigning the sub-tasks of the collaborative monitoring strategy to the group of the vehicles based on at least one of: (i) differences in audio-recording resources and capabilities across the group of vehicles; (ii) differences in video-recording resources and capabilities across the group of vehicles; or (iii) differences in motion tracking resources and capabilities across the group of vehicles.

FIG. 13 illustrates an example natural language processing-based method 1300 that may be performed by a monitoring and deterrence system 1310 to determine individuals are acting suspiciously in relation to vehicles, in accordance with various embodiments of the presently disclosed technology. Monitoring and deterrence system 1310 may be a particular implementation of deterrence system 200 from FIG. 3A, a particular implementation of collaborative deterrence system 1100 from FIG. 11, or a combination thereof.

Monitoring and deterrence system 1310 may improve upon potential alternative designs by inferring useful cues from video and audio recordings of individuals proximate vehicles, and determining the individuals are acting suspiciously based on the cues. Examples of cues may include visual cues, motion cues, audio cues, or a combination thereof.

An example visual cue may comprise an observation that a first individual is female and wearing a mask, while a second individual is male and dressed in blue jeans and a red t-shirt.

An example motion cue may comprise an observation that the first individual is looking inside vehicles while the second individual is scanning the surrounding area. As another example, a motion cue may comprise an observation that both individuals are craning their necks left and right to check the street proximate the vehicles and pausing when they notice other people nearby.

An example audio cue may comprise an observation that the first individual instructed the second individual to “check the surroundings and let me know if anyone shows up,” and “whistle when necessary.”

From these cues, monitoring and deterrence system 1310 can determine that the first and second individuals are acting suspiciously in relation to the vehicles. For example, monitoring and deterrence system 1310 may reason that the two individuals are systematically checking vehicles one by one and inspecting their interiors. Monitoring and deterrence system 1310 may further infer that the individuals are coordinating their actions using a whistle as a signal whenever someone else appears in the vicinity.

Monitoring and deterrence system 1310 can utilize one or more AI models to perform this cue-based reasoning. Relatedly, monitoring and deterrence system 1310 can utilize AI model(s) to generate the above-described cues.

For example, monitoring and deterrence system 1310 can utilize one or more AI models to generate natural language descriptions of physical characteristics (e.g., height, weight, gender, clothing, and other distinguishing physical characteristics) of the first and second individuals from the video of the two individuals. Similarly, monitoring and deterrence system 1310 can the utilize AI model(s) to generate natural language descriptions for movement patterns of the first and second individuals from the video of the two individuals. Such natural language descriptions may form a basis for the above-described visual and motion cues.

In certain implementations, the above-described AI model(s) may comprise Vision Language Model(s). As used herein, a Vision Language Model (VLM) may refer to an AI model that combines/blends computer vision and natural language processing (NLP) functionalities. For example, the VLM may combine one or more vision machine learning models with one or more NPL models (e.g., a large language model (LLM)). Accordingly, the VLM can effectively integrate visual and textual data.

An example VLM may comprise a vision encoder and a language encoder.

The vision encoder may convert image data into embeddings (e.g., numerical or vector representations) that capture key characteristics of the image data (e.g., colors, objects, shapes, textures, etc.). Examples of the vision encoder may include convolutional neural networks (CNNs) and Vision Transformers.

The language encoder may process text (i.e., natural language descriptions) to capture/understand semantic meaning and contextual relationships between words and phrases. This may involve tokenizing the text, and converting each token into an embedding (e.g., a numerical or vector representation) which represents/captures semantic meaning and contextual associations of the text associated with a given token.

To understand the embeddings derived from these two modalities, the VLM may perform a cross-modal alignment that matches embeddings of visual and textual features in a shared embedding space. After this cross-modal alignment, the VLM may fuse the embeddings / features in a shared representation space. Such fusion can help the VLM make decisions based on both modalities simultaneously.

As alluded to above, monitoring and deterrence system 1310 may utilize one or more VLMs to generate detailed natural language descriptions of the first and second individuals and their movement patterns. Such visual and motion cues, in the form of generated natural language descriptions, may then be shared among vehicles.

In some implementations, monitoring and deterrence system 1310 can also generate natural language descriptions for speech (e.g., a conversation between the first and second individuals) and non-speech-related activity (e.g., audio of one of the individuals attempting to saw off a catalytic converter from one of vehicles) of the first and second individuals based on the recorded audio of the individuals. In some implementations, this may comprise utilizing an NPL model or other AI model designed/trained to analyze audio data.

The above-described audio cues, in the form of natural language descriptions, may be integrated with the above-described visual and motion cues, and shared among vehicles.

As described above, monitoring and deterrence system 1310 can utilize the above-described cues to determine the first and second individuals are acting suspiciously in relation to vehicles. For example (and as described above), monitoring and deterrence system 1310 may reason that the two individuals are systematically checking vehicles one by one and inspecting their interiors. Monitoring and deterrence system 1310 may further infer that the two individuals are coordinating their actions using a whistle as a signal whenever someone else appears in the vicinity.

Referring now to method 1300, monitoring and deterrence system 1310 can perform operation 1302 to obtain video of one or more individuals proximate vehicles. As alluded to above, the video may be obtained from one or more video-recording cameras of the vehicles.

Monitoring and deterrence system 1310 can then perform operation 1304 to generate, from the video, natural language descriptions for physical characteristics of the one or more individuals and movement characteristics of the one or more individuals relative to the vehicles. As described above, this may involve using one or more one or more VLMs. In various implementations, the one or more VLMs may be trained on both daytime data and nighttime data where VLM-generated results can be compared to ground truth data for improvement and validation of the models.

Monitoring and deterrence system 1310 can perform operation 1306 to provide the generated natural language descriptions to a NPL model and use the NPL model to determine the one or more individuals are acting suspiciously in relation to the vehicles. In some implementations, the one or more VLMs used to generate the natural language descriptions of operation 1304 may comprise the NPL model. In various implementations, the NPL model/one or more VLMs can understand the visual, motion, and audio cues to determine that suspicious activity is actually being perpetrated by the one or more individuals.

Accordingly, monitoring and deterrence system 1310 can then perform operation 1308 to control one or more of the vehicles to deter the suspicious activity. As described above in conjunction with FIGS. 11-12, in some implementations controlling the one or more of the vehicles to deter the suspicious activity may comprise: (a) determining a collaborative strategy to deter the suspicious activity; (b) assigning sub-tasks of the collaborative deterrence strategy to a group of the vehicles based on resource and capability profiles of the group of vehicles; and (c) controlling at least one of the group of vehicles to perform its assigned sub-task of the collaborative deterrence strategy.

While not depicted in the specific example of FIG. 13, in some implementations monitoring and deterrence system 1310 can perform operations to: (1) obtain (e.g., from one or more audio sensors of the vehicles), audio associated with speech and non-speech-related activity of the one or more individuals; and (2) generate, from the audio, natural language descriptions for the speech and the non-speech-related activity of the one or more individuals. Here, the natural language descriptions for the speech and the non-speech-related activity of the one or more individuals may also be provided to the NPL and used by the NPL to determine the one or more individuals are acting suspiciously in relation to the vehicles.

FIG. 14 depicts a first example collaborative deterrence strategy, in accordance with various embodiments of the presently disclosed technology.

As depicted, collaborative deterrence system 1100 may perform/facilitate the first example collaborative deterrence strategy. In some implementations, collaborative deterrence system 1110 may be implemented across one or more of vehicles 1410, 1412, 1414, and 1416. In certain of such implementations, vehicles 1410-1416 may form a peer-to-peer/ad-hoc wireless communication network, such as a vehicular micro-cloud (VMC).

As depicted, during a time period t₁, vehicles 1410 and 1414 may record activities of individuals 1420 and 1422 in relation to vehicles 1410-1416. For example, vehicles 1410 and 1414 can utilize their video-recording cameras and audio-recording sensors respectively to record the activity of individuals 1420 and 1422.

Collaborative deterrence system 1100 can then analyze the recorded video and audio of individuals 1420 and 1422 to determine individuals 1420 and 1422 are acting suspiciously in relation to vehicles 1410-1416 (e.g., planning to, or in the process of, vandalizing or stealing from one or more of vehicles 1410-1416).

The above-described analysis may involve inferring useful cues from the video and audio recordings, and determining individuals 1420 and 1422 are acting suspiciously based on the cues. As described above, examples of cues may include visual cues, motion cues, audio cues, or a combination thereof.

In the context of FIG. 14, the visual cues may comprise an observation that individual 1422 is female and wearing a mask, while individual 1420 is male and dressed in blue jeans and a red t-shirt.

In the context of FIG. 14, the motion cues may comprise an observation that individual 1422 is looking inside vehicles 1410-1416 while individual 1420 is scanning the surrounding area. As another example, a motion cue may comprise an observation that both individuals are craning their necks left and right to check the street proximate vehicles 1410-1416 and pausing when they notice other people nearby.

In the context of FIG. 14, the audio cues may comprise an observation that individual 1422 instructed individual 1420 to “check the surroundings and let me know if anyone shows up” and “whistle when necessary.”

From these cues, collaborative deterrence system 1100 can determine that individuals 1420 and 1422 are acting suspiciously in relation to vehicles 1410-1416. For example, collaborative deterrence system 1100 may reason that the two individuals are systematically checking vehicles one by one and inspecting their interiors. Collaborative deterrence system 1100 may further infer that the individuals are coordinating their actions using a whistle as a signal whenever someone else appears in the vicinity.

As described above, collaborative deterrence system 1100 can utilize one or more AI models to perform this cue-based reasoning. Relatedly, collaborative deterrence system 1100 can utilize AI model(s) to generate the cues themselves.

For example, collaborative deterrence system 1100 can utilize one or more AI models to generate natural language descriptions of physical characteristics (e.g., height, weight, gender, clothing, and other distinguishing physical characteristics) of individuals 1420 and 1422 from the video of individuals 1420 and 1422. Similarly, collaborative deterrence system 1100 can the utilize AI model(s) to generate natural language descriptions for movement patterns of individuals 1420 and 1422 from the video of individuals 1420 and 1422.

For example, in certain implementations collaborative deterrence system 1100 may utilize one or more VLMs to generate detailed natural language descriptions of individuals 1420 and 1422 and their movement patterns. Such visual and motion cues in the form of generated natural language descriptions may then be shared among vehicles 1410-1416 during a time period t₂.

In some implementations, collaborative deterrence system 1100 can also generate natural language descriptions for speech (e.g., a conversation between individuals 1420 and 1422) and non-speech-related activity (e.g., audio of one of the individuals attempting to saw off a catalytic converter from one of vehicles 1410-1416) of individuals 1420 and 1422 based on the recorded audio of individuals 1420 and 1422. In some implementations, this may comprise utilizing an NPL or other AI model.

Accordingly, these audio cues in the form of natural language descriptions may be integrated with the above-described visual and motion cues, and shared among vehicles 1410-1416 at the time period t₂.

As described above, collaborative deterrence system 1100 (which again, may be implemented across one or more of vehicles 1410-1416) can utilize the above-described cues to determine individuals 1420 and 1422 are acting suspiciously in relation to vehicles 1410-1416. For example (and as described above), collaborative deterrence system 1100 may reason that the two individuals are systematically checking vehicles one by one and inspecting their interiors. Collaborative deterrence system 1100 may further infer that the individuals are coordinating their actions using a whistle as a signal whenever someone else appears in the vicinity.

Based on the inferences/reasoning above, along with resource and capability profiles for vehicles 1410-1416, collaborative deterrence system 1100 can determine a collaborative strategy for deterring the suspicious activity.

In the specific example of FIG. 14, this may involve checking a lookup table (or a similar structured format for storing data). Each entry of the lookup table may correspond with at least one of: (i) the inference/reasoning of collaborative deterrence system 1100 that forms a basis for determining individuals 1420 and 1422 are acting suspiciously; or (ii) the resource and capability profiles of vehicles 1410-1416.

In the specific example of FIG. 14, the collaborative deterrence strategy selected from the lookup table may involve displaying individual 1422's activity on a display of vehicle 1412 and replaying individual 1420's recorded audio through a speaker of vehicle 1416. This first example collaborative deterrence strategy may instill a belief in the suspicious individuals that they have been tracked from the beginning, signaling that all vehicles in the vicinity are aware of their actions, thereby enhancing the deterrent effect.

As depicted, during a time period t₃, collaborative deterrence system 1100 can orchestrate/control vehicles 1412 and 1416 to perform their respective assigned sub-tasks of the first example collaborative deterrence strategy.

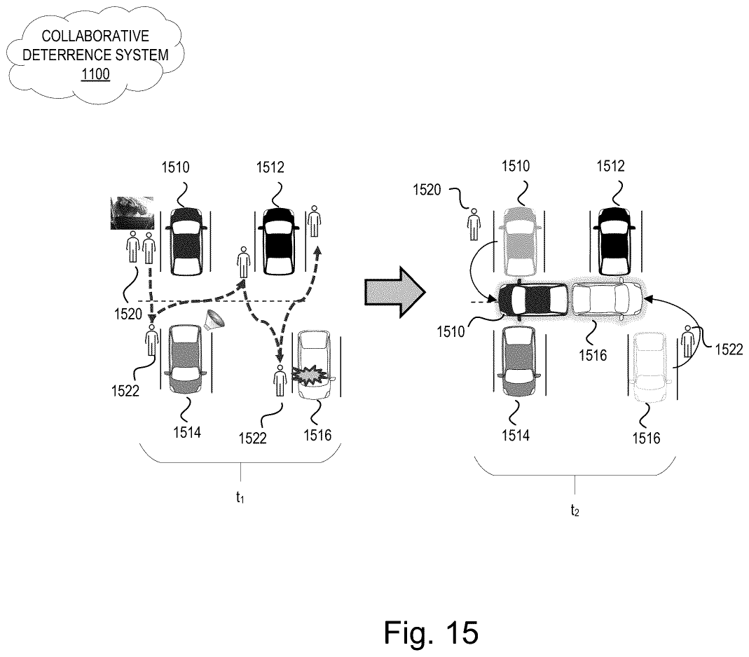

FIG. 15 depicts a second example collaborative deterrence strategy, in accordance with various embodiments of the presently disclosed technology.

As depicted, collaborative deterrence system 1100 may perform/facilitate the second example collaborative deterrence strategy. In some implementations, collaborative deterrence system 1100 may be implemented across one or more of vehicles 1510, 1512, 1514, and 1516.

As depicted, during a time period t₁, vehicles 1510 and 1514 may record activities of individuals 1520 and 1522 in relation to vehicles 1510-1516. This may be performed in the same/similar manner as described in conjunction with FIG. 14.

Collaborative deterrence system 1100 can then analyze the recorded video and audio of individuals 1520 and 1522 to determine individuals 1520 and 1522 are acting suspiciously in relation to vehicles 1510-1516 (e.g., planning to, or in the process of, vandalizing or stealing from vehicles 1510-1516). This may be performed in the same/similar manner as described in conjunction with FIG. 14.

In the specific example of FIG. 15, collaborative deterrence system 1100 may check a lookup table and not find a pre-defined collaborative deterrence strategy that corresponds to the scenario of FIG. 15. As described above, such a scenario may be defined based on at least one of: (1) the reasoning/inferences made by collaborative deterrence system 1100 that form a basis for the determination that individuals 1520 and 1522 are acting suspiciously; or (2) resource and capability profiles of vehicles 1510-1516.

In the absence of a pre-defined collaborative deterrence strategy, collaborative deterrence system 1100 can use an AI or machine learning (ML) model to analyze the resource and capability profiles of vehicles 1510-1516 to determine a new collaborative deterrence strategy. For example, collaborative deterrence system 1100 may learn/determine that vehicles 1510 and 1516 are equipped with autonomous or semi-autonomous driving systems. Based on this insight, collaborative deterrence system 1100 may use the AI/ML model to devise a group movement strategy, where vehicles 1510 and 1516 make successive autonomous maneuvers to draw the attention of individuals 1520 and 1522, as well as passers-by. The maneuvers may be executed periodically, ensuring that the deterrence effect is enhanced and continuously reinforced.

As depicted, collaborative deterrence system 1100 can orchestrate/control vehicles 1510 and 1516 to perform this second example collaborative deterrence strategy at a time period t₂.

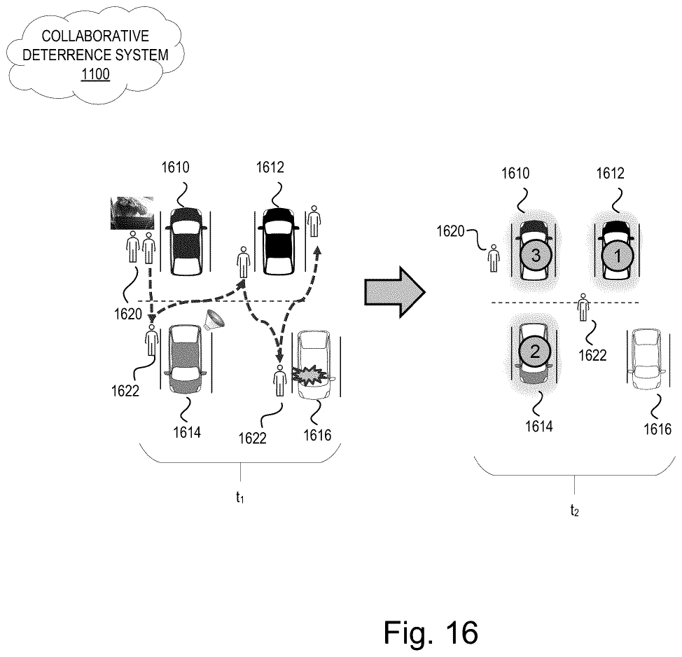

FIG. 16 depicts a third example collaborative deterrence strategy, in accordance with various embodiments of the presently disclosed technology.

As depicted, collaborative deterrence system 1100 may perform/facilitate the third example collaborative deterrence strategy. In some implementations, collaborative deterrence system 1100 may be implemented across one or more of vehicles 1610, 1612, 1614, and 1616.

As depicted, during a time period t₁, vehicles 1610 and 1614 may record activities of individuals 1620 and 1622 in relation to vehicles 1610-1616. This may be performed in the same/similar manner as described in conjunction with FIG. 14.

Collaborative deterrence system 1100 can then analyze the recorded video and audio of individuals 1620 and 1622 to determine individuals 1620 and 1622 are acting suspiciously in relation to vehicles 1610-1616 (e.g., planning to, or in the process of, vandalizing or stealing from vehicles 1610-1616). This may be performed in the same/similar manner as described in conjunction with FIG. 14.

In the specific example of FIG. 16, collaborative deterrence system 1100 may check a lookup table and find a pre-defined collaborative deterrence strategy that corresponds to the scenario of FIG. 16. As described above, such a scenario may be defined based on at least one of: (1) the reasoning/inferences made by collaborative deterrence system 1100 that form a basis for the determination that individuals 1620 and 1622 are acting suspiciously; or (2) resource and capability profiles of vehicles 1610-1616.

The collaborative deterrence strategy from the lookup table may involve activating vehicle 1612's alarm early, triggered by its in-cabin sensor detecting a valuable left behind item. Simultaneously, collaborative deterrence system 1100 can successively activate the alarms of vehicles 1614 and 1610 respectively. Accordingly, there may be a cascaded sequence of alarms (i.e., the alarm of vehicle 1612 first, the alarm of vehicle 1614 second, and the alarm of vehicle 1616 third) that draws increased public attention and reinforces the deterrent effect. In some implementations, the alarms may be sequenced in the order that individual 1622 approached the vehicles. This may instill a belief in the suspicious individuals that they have been tracked from the beginning, and may further disorient/deter the suspicious individuals.

As depicted, collaborative deterrence system 1100 can orchestrate/control vehicles 1612, 1614, and 1610 to perform this third example collaborative deterrence strategy at a time period t₂.

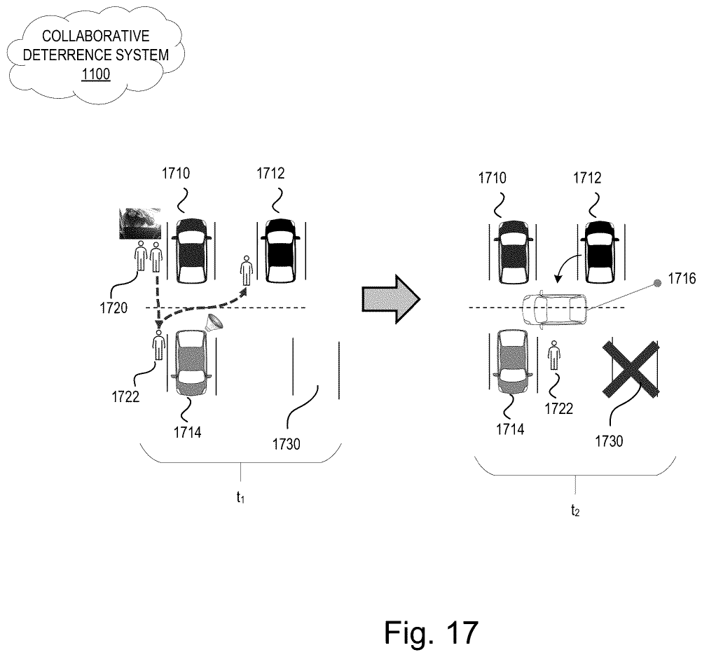

FIG. 17 depicts a fourth example collaborative deterrence strategy, in accordance with various embodiments of the presently disclosed technology.

As depicted, collaborative deterrence system 1100 may perform/facilitate the fourth example collaborative deterrence strategy. In some implementations, collaborative deterrence system 1100 may be implemented across one or more of vehicles 1710, 1712, 1714, and 1716.

As depicted, during a time period t₁, vehicles 1710 and 1714 may record activities of individuals 1720 and 1722 in relation to vehicles 1710-1714. This may be performed in the same/similar manner as described in conjunction with FIG. 14.

Collaborative deterrence system 1100 can then analyze the recorded video and audio of individuals 1720 and 1722 to determine individuals 1720 and 1722 are acting suspiciously in relation to vehicles 1710-1716 (e.g., planning to, or in the process of, vandalizing or stealing from vehicles 1710-1716). This may be performed in the same/similar manner as described in conjunction with FIG. 14.

In the specific example of FIG. 17, collaborative deterrence system 1100 may determine a collaborative deterrence strategy that involves one or more of vehicles 1710-1714 sending a warning notification to a vehicle looking to park in empty space 1730 (e.g., vehicle 1716).

For example, at a time period t₂, collaborative deterrence system 1100 can orchestrate/control vehicle 1712 to send a warning notification to vehicle 1716 when vehicle 1712 detects/predicts that vehicle 1716 is beginning to park in empty space 1730. In various implementations, the warning notification may be displayed on a graphical user interface of vehicle 1716. In certain implementations, the warning notification may be sent to an autonomous driving system implemented in vehicle 1716.

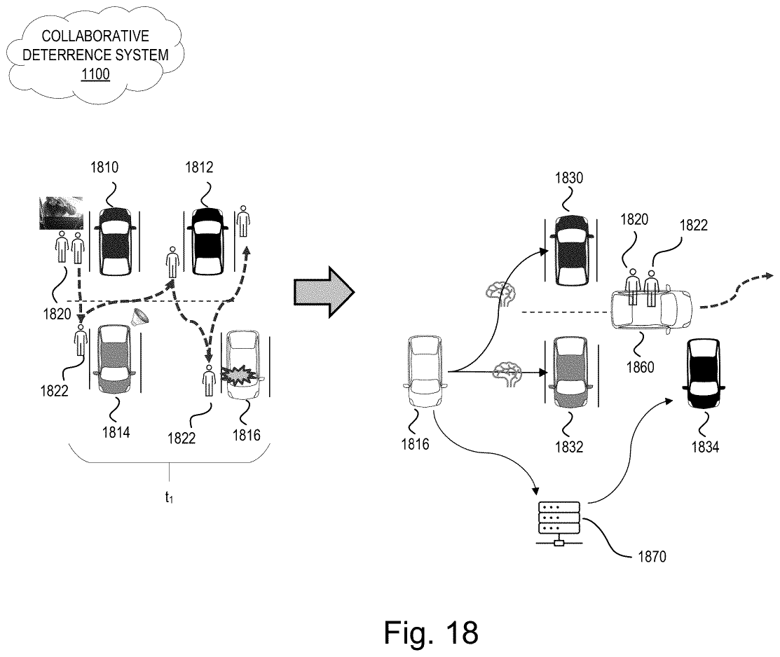

FIG. 18 depicts a fifth example collaborative deterrence strategy, in accordance with various embodiments of the presently disclosed technology.

As depicted, collaborative deterrence system 1100 may perform/facilitate the fifth example collaborative deterrence strategy. In some implementations, collaborative deterrence system 1100 may be implemented across one or more of vehicles 1810, 1812, 1814, 1816, 1830, 1832 and 1834.

As depicted, during a time period t₁, vehicles 1810 and 1814 may record activities of individuals 1820 and 1822 in relation to vehicles 1810-1814. This may be performed in the same/similar manner as described in conjunction with FIG. 14.

Collaborative deterrence system 1100 can then analyze the recorded video and audio of individuals 1820 and 1822 to determine individuals 1820 and 1822 are acting suspiciously in relation to vehicles 1810-1816 (e.g., planning to, or in the process of, vandalizing or stealing from vehicles 1810-1816). This may be performed in the same/similar manner as described in conjunction with FIG. 14.

In the specific example of FIG. 18, collaborative deterrence system 1100 can determine a collaborative deterrence strategy that involves tracking/monitoring individuals 1820 and 1822 as they attempt to flee in vehicle 1860.

For example, collaborative deterrence system 1100 can infer that the suspicious individuals are using vehicle 1860 to flee the scene. Collaborative deterrence system 1100 (including the vehicles it is implemented across) can identify vehicle 1860 through its inferred feature set/unique characteristics. Accordingly, nearby vehicles can be notified about vehicle 1860 and its feature set/unique characteristics. For example, collaborative deterrence system 1100 can initiate a tracking request for vehicle 1860. In response to this tracking request, at time period t₂, vehicle 1816 may transfer its knowledge regarding vehicle 1860 to one or more of vehicle 1830, vehicle 1832, and law enforcement server 1870. Law enforcement server 1870 may then transfer this knowledge to vehicle 1834. As depicted, collaborative deterrence system 1100/vehicle 1816 can intelligently transfer knowledge to these vehicles based on a prediction of vehicle 1860's navigation route (e.g., a navigation route that passes proximate vehicles 1830, 1832 and 1834).

Thus, in accordance with this fifth example collaborative deterrence strategy, collaborative deterrence system 1100 can accumulate inferred features from suspicious individuals and their vehicles, enabling coordinated tracking across multiple vehicles. These vehicles can monitor and record the movement of the suspicious individuals, including routes taken and directions traveled. This real-time information can be shared with law enforcement, enhancing their ability to respond effectively.

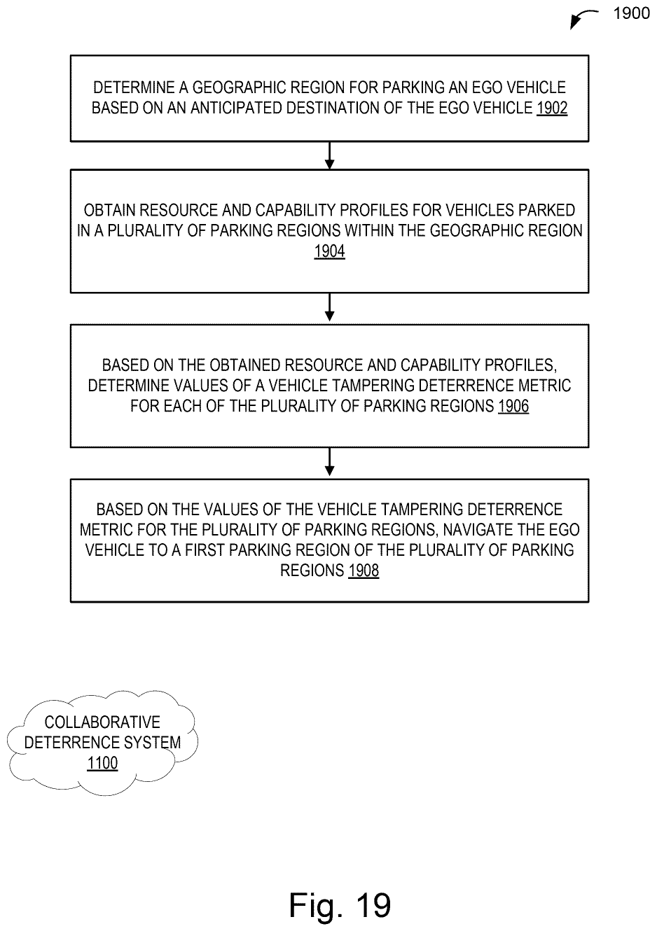

FIGS. 19-28 illustrate example systems and methods for enhancing vehicle security for a geographic region through intelligent and proactive parking selection guidance.

As described above, systems and methods of the presently disclosed technology may be implemented to execute collaborative vehicle tampering deterrence strategies that may be more effective at deterring vehicle tampering (or other suspicious) activity than existing vehicle security systems that operate independently without coordination.

However, vehicle occupants are generally unaware of how they might contribute to, and benefit from, collaborative vehicle tampering deterrence strategies in different parking regions when they are deciding where to park. More generally, vehicle occupants are typically unaware of the how they might enhance vehicle tampering deterrence capabilities of the different parking regions when they are deciding where to park. Instead, such occupants are traditionally focused on finding the most easily accessible or visible empty parking spot.

Related to above, existing parking assistance technologies generally lack tools for proactively guiding drivers to park in locations where their vehicle can best contribute to, and benefit from, vehicle tampering deterrence. Instead, existing parking assistance technologies generally focus on detecting and communicating real-time or predicted parking availability status. Similarly, existing vehicle security technologies generally focus on post-parking security measures that respond when vehicle tampering or other suspicious activity is detected. In sum, these existing technologies do not address proactive enhancement of overall parking area security by factoring in the potential surveillance and deterrence contributions of newly arriving vehicles during the parking selection process.

Against this backdrop, systems and methods of the presently disclosed technology may be implemented to enhance vehicle security for a geographic region through intelligent and proactive parking selection guidance.

In some implementations, this may involve assessing the existing vehicle tampering deterrence capabilities at different parking regions within a geographic region. Based on this assessment and the resources and capabilities of an ego vehicle, a presently disclosed system may automatically navigate the ego vehicle to a parking region (e.g., a particular parking lot or a particular region within the parking lot) that would benefit the most from the ego vehicle's contribution to vehicle tampering deterrence. In some implementations, this may involve autonomously controlling the ego vehicle to an available parking spot within the parking region. In other implementations, navigating the ego vehicle to the parking region may involve displaying, on a graphical user interface (GUI) of the ego vehicle, a navigation route to the parking region to guide a human driver to the parking region.

In various implementations, the presently disclosed systems and methods may be implemented to display graphical representations (e.g., on a dashboard GUI) that help a vehicle occupant understand and appreciate how their vehicle may enhance vehicle tampering deterrence capabilities in different parking regions. Examples of the graphical representations may include, inter alia, (1) audio-visual recreations of collaborative vehicle tampering deterrence strategies that would be enabled if their vehicle were to park in a respective parking region, (2) enhancements to a value of a vehicle tampering deterrence metric for the respective parking region that would result from their vehicle parking in the respective parking region, or some combination thereof. Based on these graphical representations, the vehicle occupant may better understand and appreciate how their vehicle can contribute to, and benefit from, vehicle tampering deterrence in the different parking regions. Such understanding and appreciation may better inform the vehicle occupant's decision of where to park their vehicle. Relatedly, in some implementations, the vehicle occupant may select a parking region based on the foregoing graphical representations by interacting with a GUI that displays the graphical representations (e.g., via a touch-screen interface). Responsive to this selection, the presently disclosed systems and methods can navigate the vehicle to the parking region in the manner described above.

In some implementations, the presently disclosed systems and methods can incorporate or integrate with various types of systems that provide incentives to vehicle occupants or owners for choosing to park in a location that improves overall security for a parking region or larger geographic area. Examples of such incentives may include various types of financial incentives (e.g., reduced parking fees, parking vouchers or credits, reductions in monthly car insurance premiums), prize incentives (e.g., tickets to a sporting event or concert), and other incentives.

For example, in one implementation a presently disclosed system may integrate with a payment system at a first parking lot to reduce parking fees for an ego vehicle responsive to an occupant of the ego vehicle selecting to park in the first parking lot. As described above, the occupant may select the first parking lot after the system displays a graphical representation showing how the ego vehicle could enhance the vehicle tampering deterrence capabilities at the first parking lot. In certain implementations, this graphical representation may also convey that parking fees would be reduced at the first parking lot. The combination of the reduced parking fees and an appreciation of how the ego vehicle could enhance (and thus also benefit from) the vehicle tampering deterrence capabilities at the first parking lot may convince the occupant to park in the first parking lot. This may be the case even where a second parking lot is closer to the occupant's ultimate destination. However, the second parking lot may already have significant vehicle tampering deterrence capabilities. Accordingly, the first parking lot may benefit from the ego vehicle's contributions more than the second parking lot, and overall vehicle security for the geographic region may be enhanced by having the ego vehicle park in the first parking lot.

FIG. 19 illustrates an example method 1900 that may be performed by collaborative deterrence system 1100 to navigate an ego vehicle to a parking region to improve vehicle tampering deterrence capabilities at the parking region, in accordance with various embodiments of the presently disclosed technology.

Collaborative deterrence system 1100 can perform operation 1902 to determine a geographic region for parking an ego vehicle based on an anticipated destination for the ego vehicle.

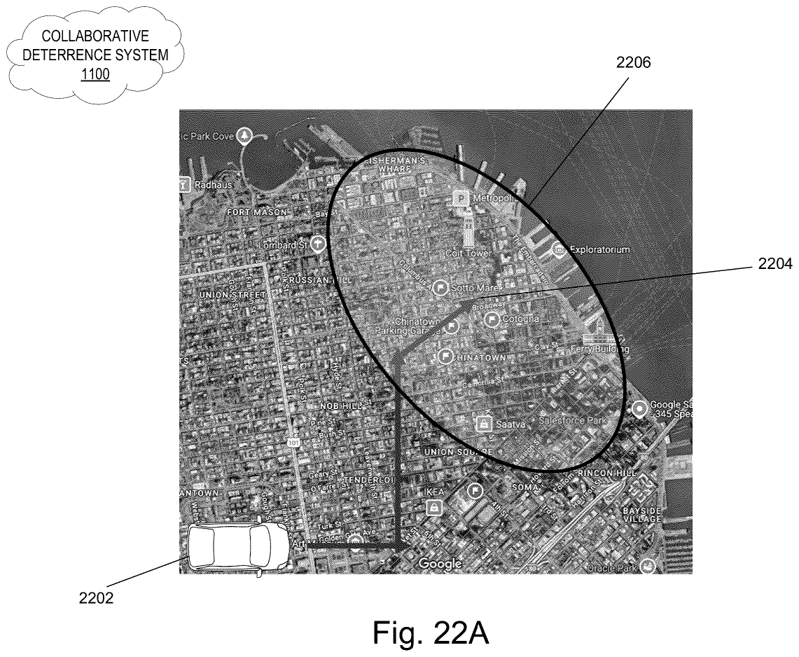

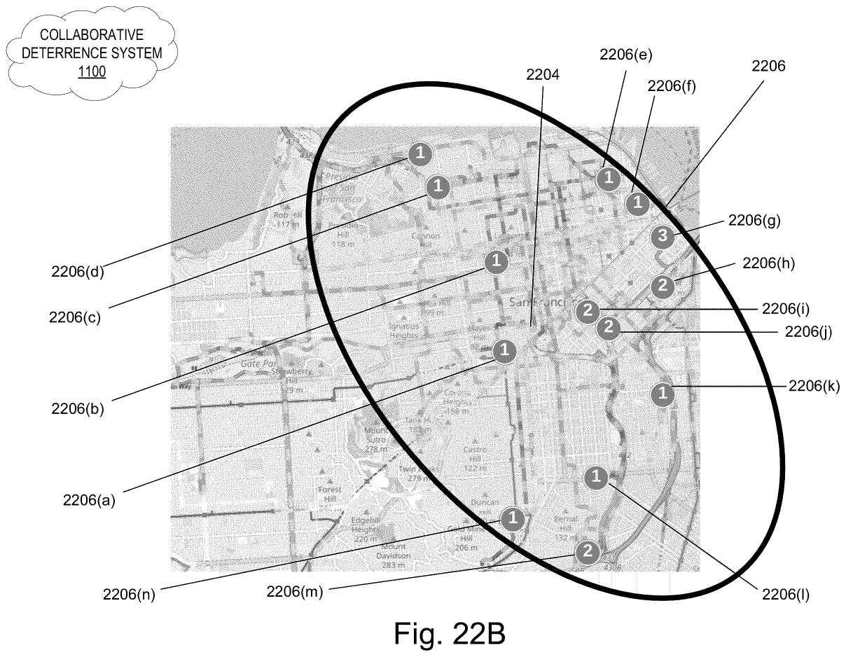

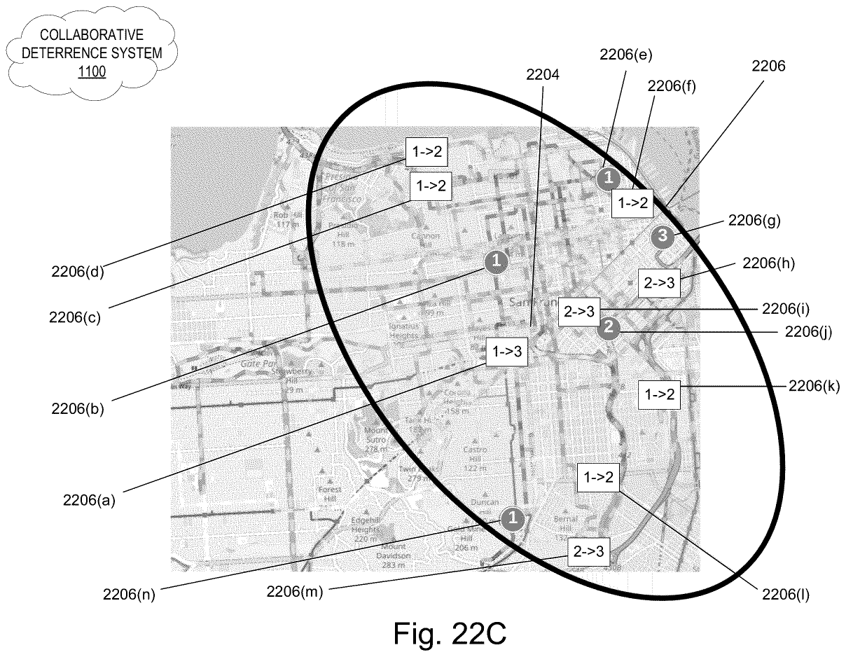

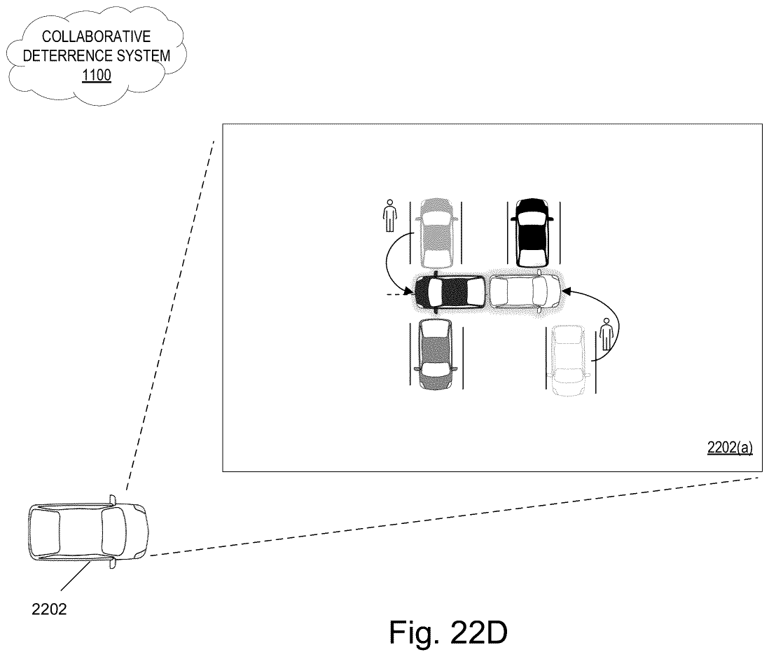

For example, and as depicted in FIG. 22A, collaborative deterrence system 1100 can determine a geographic region 2206 for parking an ego vehicle 2202 based on an anticipated destination 2204 for ego vehicle 2202.

In some implementations, collaborative deterrence system 1100 may determine anticipated destination 2204 from at least one of: (a) a preset destination of a navigation system of ego vehicle 2202; or (2) a preset destination of a navigation system communicatively coupled to ego vehicle 2202.

In other implementations, collaborative deterrence system 1100 may infer or predict anticipated destination 2204 based on past driving trips of ego vehicle 2202. For example, ego vehicle 2202 may frequently travel to park near a city courthouse during weekday mornings. Accordingly, collaborative deterrence system 1100 may infer or predict that the city courthouse as anticipated destination 2204 when ego vehicle 2202 is traveling in the direction of the city courthouse on a weekday morning.

In various implementations, collaborative deterrence system 1100 may infer or predict that ego vehicle 2202 (or more specifically, a driver of ego vehicle 2202) is looking for parking based on contemporaneous driving activity of ego vehicle 2202. For example, collaborative deterrence system 1100 may detect that ego vehicle 2202 is circling a location, or driving slower than normal in a city area. Accordingly, collaborative deterrence system 1100 may infer or predict anticipated destination 2204 based on these detections.

Collaborative deterrence system 1100 can use various techniques to determine geographic region 2206 from anticipated destination 2204. For example, in some implementations geographic region 2206 may comprise a region of a pre-determined radius centered around anticipated destination 2204. In certain of such implementations, the shape or radius of geographic region 2206 may be adjusted based on area-specific landscape or civic planning features (e.g., a body of water that restricts parking availability, lack of parking or road access in a particular direction from anticipated destination 2204, etc.).

Collaborative deterrence system 1100 can perform operation 1904 to obtain resource and capability profiles for vehicles parked in a plurality of parking regions within the geographic region. The resource and capability profiles may be obtained by collaborative deterrence system 1100 through communications with vehicle on-board systems or connected vehicle platforms.

For example, and as depicted in FIG. 22B, collaborative deterrence system 1100 can obtain resource and capability profiles for vehicles parked in parking regions 2206(a)-(n) within geographic region 2206. In some implementations, this may involve identifying parking regions 2206(a)-(n) as parking regions with at least one available parking spot. In various of such implementations, collaborative deterrence system 1100 can leverage integrations with real-time parking availability systems (or similar technologies) to identify the available parking spots.

In some implementations, parking regions 2206(a)-(n) may comprise individual parking lots, regions within individual parking lots, individual parking structures or garages, regions within individual parking structures or garages (e.g., individual floors or regions of individual floors), regions of on-the-street parking, or some combination thereof.

In certain implementations, the resource and capability profile for a respective vehicle may comprise at least one of: (i) sensor resources of the respective vehicle (e.g., cameras, Lidar, Radar, or other sensors); (ii) processing resources of the respective vehicle (e.g., an amount of computing power); (iii) memory resources of the respective vehicle (e.g., an amount of memory storage); (iv) wireless communication resources of the respective vehicle (e.g., V2V Wifi, V2N Wifi, other V2V or V2N communication capabilities, etc.); (v) audio-visual output capabilities of the respective vehicle (e.g., sirens, alarms, lights, visual displays, etc.); or (vi) autonomous driving capabilities of the respective vehicle (e.g., advanced parking assist, L1-L5 autonomy, etc.).

Based on the obtained resource and capability profiles, collaborative deterrence system 1100 can perform operation 1906 to determine values of a vehicle tampering deterrence metric for each of the plurality of parking regions. Such values may quantify vehicle tampering deterrence capabilities at the respective parking regions.

For example, collaborative deterrence system 1100 can determine values of a vehicle tampering deterrence metric for each of parking regions 2206(a)-(n).

In some implementations, the value of the vehicle tampering deterrence metric for a respective parking region may quantify at least one of: (i) a number of vehicles with vehicle tampering deterrence features in the respective parking region (e.g., sirens, alarms, video recording, parking assist or autonomous driving features, high intensity lights, automated communication with connected authorities, etc.); (ii) a number of vehicles capable of contributing to at least one collaborative vehicle tampering deterrence strategy in the respective parking region; (iii) a number of unique collaborative vehicle tampering deterrence strategies that can be implemented by vehicles parked in the respective parking region; or (iv) resources and capabilities of vehicles parked in the respective parking region which can contribute to at least one collaborative vehicle tampering deterrence strategy. For example, in certain implementations the value of the vehicle tampering deterrence metric for the respective parking region may comprise a weighted score based on at least one of (i)-(iv) above. In other implementations, the vehicle tampering deterrence metric may comprise a categorical or numerical classification based on at least one of (i)-(iv) above.

Based on the values of the vehicle tampering deterrence metric for the plurality of parking regions, collaborative deterrence system 1100 can perform operation 1908 to navigate the ego vehicle to a first parking region of the plurality of parking regions.

For example, collaborative deterrence system 1100 can navigate ego vehicle 2202 to parking region 2206(a). In some implementations, this may comprise navigating ego vehicle 2202 to an available parking spot in parking region 2206(a).

In some implementations, navigating ego vehicle 2202 to parking region 2206(a) may comprise autonomously controlling ego vehicle 2202 along a route to parking region 2206(a). In other implementations, navigating ego vehicle 2202 to parking region 2206(a) may comprise displaying a navigation route to parking region 2206(a) on a graphical user interface (GUI) (e.g., a dashboard screen) of ego vehicle 2202 to guide a driver of ego vehicle 2202.

Collaborative deterrence system 1100 can determine to navigate ego vehicle 2202 to parking region 2206(a) in various ways. For example, in certain implementations collaborative deterrence system 1100 can first determine ego vehicle 2202's potential enhancements to the values of the vehicle tampering deterrence metric for the plurality of parking regions. In other words, collaborative deterrence system 1100 can determine an impact of ego vehicle 2202's potential contribution to the value of the vehicle tampering deterrence metric for each of parking regions 2206(a)-(n).

For example, collaborative deterrence system 1100 may determine that ego vehicle 2202 would enhance the value of the vehicle tampering deterrence metric for parking region 2206(a) by the greatest amount among parking regions 2206(a)-(n), and navigate ego vehicle to parking region 2206(a) accordingly. In scenarios where collaborative deterrence system 1100 determines that ego vehicle 2202 would enhance the values of the vehicle tampering deterrence metric for additional parking regions by the same or similar amounts, collaborative deterrence system 1100 can determine to navigate ego vehicle to parking region 2206(a) because parking region 2206(a) is closer to anticipated destination 2204 than these additional parking regions. In addition or alternative to the foregoing, collaborative deterrence system 1100 may determine that parking region 2206(a) would have the lowest value of the vehicle tampering deterrence metric absent ego vehicle 2202's enhancement, and navigate ego vehicle 2202 to parking region 2206(a) accordingly. In other words, collaborative deterrence system 1100 may determine that parking region 2206(a) is in the greatest need of ego vehicle 2202, and navigate ego vehicle 2202 to parking region 2206(a) accordingly. In scenarios where collaborative deterrence system 1100 determines that additional parking regions have the same or similar needs for ego vehicle 2202, collaborative deterrence system 1100 can determine to navigate ego vehicle to parking region 2206(a) because parking region 2206(a) is closer to anticipated destination 2204 than these additional parking regions.

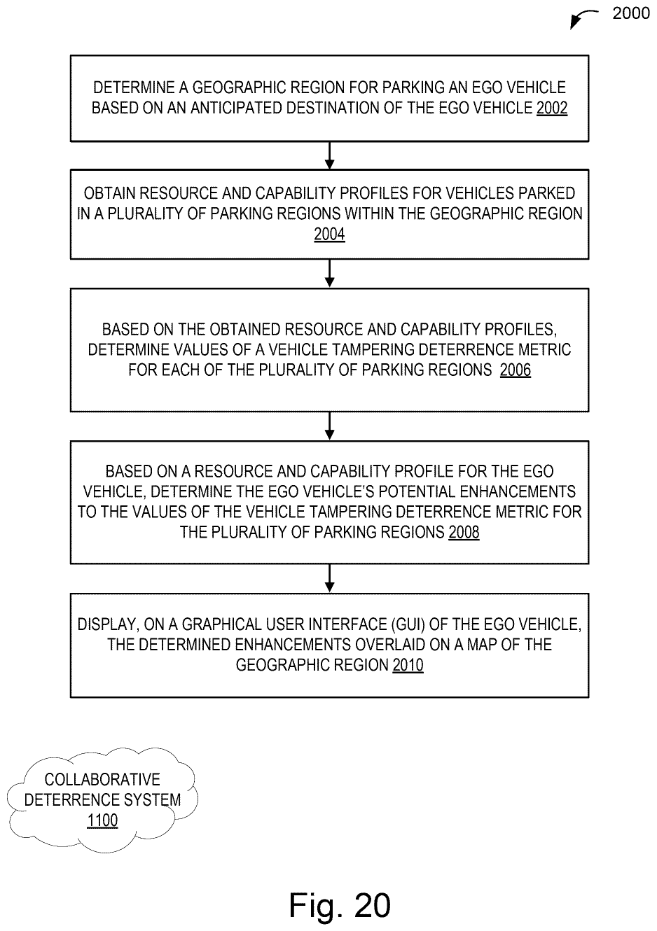

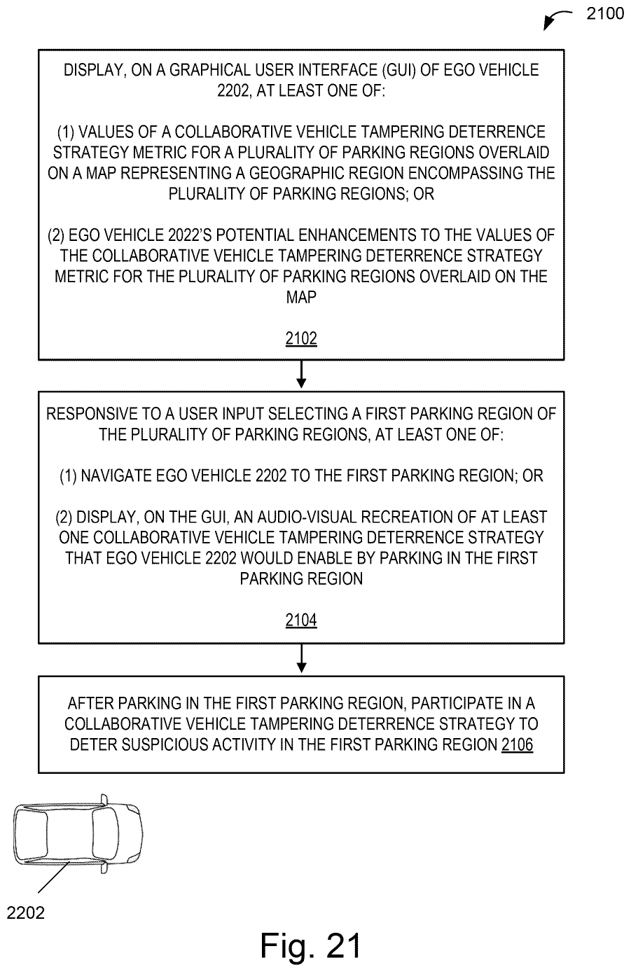

As described in greater detail in conjunction with FIGS. 20 and 21, in some implementations collaborative deterrence system 1100 may navigate ego vehicle 2202 to parking region 2206(a) responsive to an occupant of ego vehicle 2202 selecting parking region 2206(a) (e.g., via a touch-screen GUI of ego vehicle 2202). The occupant may provide this selection after collaborative deterrence system 1100 provides information (e.g., via the touch-screen GUI of ego vehicle 2202) related to at least one of: (i) values of the vehicle tampering deterrence metric for parking regions 2206(a)-(n) absent ego vehicle 2202's enhancements/contributions; or (ii) ego vehicle 2202's potential enhancements to the values of the vehicle tampering deterrence metric for these parking regions. Such information may help the occupant understand and appreciate the enhancements/contributions that ego vehicle 2202 can make, and better inform the occupant's decision of where to park ego vehicle 2202.

FIG. 20 illustrates an example method 2000 that may be performed by collaborative deterrence system 1100 to visualize, for an occupant of an ego vehicle, the ego vehicle's potential enhancements to vehicle tampering deterrence capabilities for different parking regions, in accordance with various embodiments of the presently disclosed technology.

Collaborative deterrence system 1100 can perform operation 2002 to determine a geographic region for parking an ego vehicle based on an anticipated destination for the ego vehicle. For example, and as depicted in FIG. 22A, collaborative deterrence system 1100 can determine geographic region 2206 for parking ego vehicle 2202 based on anticipated destination 2204. Collaborative deterrence system 1100 can perform this operation in the same/similar manner as described above for operation 1902.

Collaborative deterrence system 1100 can perform operation 2004 to obtain resource and capability profiles for vehicles parking in a plurality of parking regions within the geographic region. For example, and as depicted in FIG. 22B, collaborative deterrence system 1100 can obtain resource and capability profiles for vehicles in parking regions 2206(a)-(n) within geographic region 2206. Collaborative deterrence system 1100 can perform this operation in the same/similar manner as described above for operation 1904.

Based on the obtained resource and capability profiles, collaborative deterrence system 1100 can perform operation 2006 to determine values of a vehicle tampering deterrence metric for each of the plurality of parking regions. For example, collaborative deterrence system 1100 can determine values of a vehicle tampering deterrence metric for each of parking regions 2206(a)-(n). Collaborative deterrence system 1100 can perform this operation in the same/similar manner as described above for operation 1906.

Based on a resource and capability profile for the ego vehicle, collaborative deterrence system 1100 can perform operation 2008 to determine the ego vehicle's potential enhancements to the values of the vehicle tampering deterrence metric for the plurality of parking regions.

For example, based on a resource and capability profile for ego vehicle 2202, collaborative deterrence system 1100 can determine ego vehicle 2022's potential enhancements to the values of the vehicle tampering deterrence metric for parking regions 2206(a)-(n). In other words, collaborative deterrence system 1100 can determine an impact of ego vehicle 2202's potential contribution to the respective values if the vehicle tampering deterrence metric for parking regions 2206(a)-(n).

As described above, the resource and capability profile for ego vehicle 2202 may comprise at least one of: (i) sensor resources of ego vehicle 2202 (e.g., cameras, Lidar, radar, or other sensors); (ii) processing resources of ego vehicle 2202 (e.g., an amount of computing power); (iii) memory resources of ego vehicle 2202 (e.g., an amount of memory storage); (iv) wireless communication resources of ego vehicle 2202 (e.g., V2V Wifi, V2N Wifi, other V2V or V2N communication capabilities, etc.); (v) audio-visual output capabilities of ego vehicle 2202 (e.g., sirens, alarms, lights, visual displays, etc.); or (vi) autonomous driving capabilities of ego vehicle 2202 (e.g., advanced parking assist, L1-L5 autonomy, etc.).

As described above, collaborative deterrence system 1100 can determine ego vehicle 2202's potential enhancements to the values of the vehicle tampering deterrence metric for the parking regions 2206(a)-(n) in various ways. In some implementations, this may involve determining an amount (if any) by which ego vehicle 2202 would enhance the value of the vehicle tampering deterrence metric for each of parking regions 2206(a)-(n).

For example, and as depicted in FIG. 22C, collaborative deterrence system 1100 may determine that ego vehicle 2202 would enhance/increase the value of the vehicle tampering deterrence metric for parking region 2206(a) from “1” to “3”. By contrast, collaborative deterrence system 1100 may determine that ego vehicle 2202 would not enhance/increase the value of the vehicle tampering deterrence metric for parking region 2206(b) from its prior value of “1”. As depicted in FIG. 22C, collaborative deterrence system 1100 may determine similar enhancements (or lack thereof) for the other parking regions in geographic region 2206 as well.

In the specific example of FIG. 22C where the values of the vehicle tampering deterrence metric are numerical values, the above-referenced enhancements may correspond with an increase in the numerical values. As may be appreciated however, in implementations where the values of the vehicle tampering deterrence metric comprise categorical or other values, the above-referenced enhancements may take different forms. For example, in an implementation where the values of the vehicle tampering deterrence metric comprise a categorical hierarchy (e.g., “low,” “medium” or “high”), the above-referenced enhancements may take the form of a change in category up the hierarchy (e.g., a change from “low” to “medium,” a change from “low” to “high,” etc.).

In various implementations, ego vehicle 2202 may enhance the values of the vehicle tampering deterrence metric for different parking regions by different amounts depending on how complementary ego vehicle 2202's resource and capability profile is with the resource and capability profiles of other vehicles parked in the respective parking region. For example, ego vehicle 2202 may enhance the value of the vehicle tampering deterrence metric for parking region 2206(a) by a greater amount than for parking regions 2206(b) and 2202(c) because ego vehicle 2202 has a more complementary resource and capability profile with the vehicles parked in parking region 2206(a) than with the vehicles parked in parking regions 2206(b) and 2206(c). In various scenarios, the complementary nature of ego vehicle 2202's resource and capability profile may enable the vehicles parked within parking region 2206(a) to perform a greater number or diversity of collaborative vehicle tampering deterrence strategies. In addition or alternative to the foregoing, the complementary nature of ego vehicle 2202's resource and capability profile may enhance the effectiveness of one or more collaborative vehicle tampering deterrence strategies that the vehicles of parking region 2206(a) could perform absent ego vehicle 2202's contributions. For example, the vehicles currently parked in parking region 2206(a) may already be able to perform a collaborative vehicle tampering deterrence strategy that involves a sequential triggering of alarms by multiple vehicles to follow a suspicious individual as the suspicious individual moves through parking region 2206(a). However, the addition of ego vehicle 2202 may allow such a sequential triggering of alarms to follow the suspicious individual for a longer distance.

Referring again to FIG. 20, collaborative deterrence system 1100 may perform operation 2010 to display, on a GUI of the ego vehicle, the determined enhancements from operation 2008 overlaid on a map of the geographic region.

For example, collaborative deterrence system 1100 may display, on a GUI of ego vehicle 2202, the determined enhancements from operation 2008 overlaid on a map of geographic region 2206.

As alluded to above, FIG. 22C provides one illustrative example of what can be displayed on the GUI of ego vehicle 2202. As depicted, an indicator box is overlaid on parking region 2206(a)'s location on a map. The indicator box illustrates an enhancement in the value of the vehicle tampering deterrence metric from “1” to “3”. Similarly, an indicator box illustrating no enhancement is overlaid on parking region 2206(b)'s location on the map. Indicator boxes illustrating enhancements (or lack thereof) for the values of the vehicle tampering deterrence metric for the other parking regions are similarly overlaid on their respective locations on the map.

As may be appreciated, different visual indicators may be used to illustrate enhancements (or lack thereof) for the values of the vehicle tampering deterrence metric for parking regions 2206(a)-(n). For example, color-coding (e.g., a color scale that quantifies an amount of enhancement) may be used to illustrate enhancements (or lack thereof) while numerical (or categorical) symbols are used to illustrate the values of the vehicle tampering deterrence metric for parking regions 2206(a)-(n) resulting from ego vehicle 2202's potential enhancements (or lack thereof). In other implementations, values of the vehicle tampering deterrence metric before and after ego vehicle 2202's enhancements may be shown (or flashed) in sequence to illustrate enhancements.

By any of these techniques, the visual information displayed on the GUI of ego vehicle 2202 may help an occupant of ego vehicle 2202 understand and appreciate the enhancements/contributions that ego vehicle 2202 can make to vehicle tampering deterrence, and better inform the occupant's decision of where to park ego vehicle 2202. As described in greater detail in conjunction with FIG. 21, in certain implementations this may involve the occupant selecting, on the GUI (e.g., via a touch-screen interface), one of parking regions 2206(a)-(n) to park in. For example, the occupant may select parking region 2206(a) by touching a region of the GUI proximate where parking region 2206(a) is displayed. Responsive to this selection, collaborative deterrence system 1100 can navigate ego vehicle 2202 to parking region 2206(a). As described above, such navigation may involve autonomously controlling ego vehicle 2202 to parking region 2206(a), displaying a navigation route to parking region 2206(a) on the GUI, or some combination thereof.

FIG. 21 illustrates an example method 2100 that may be performed by ego vehicle 2202 to display audio-visual recreations of collaborative vehicle tampering deterrence strategies that the ego vehicle would enable in a parking region, in accordance with various embodiments of the presently disclosed technology. Ego vehicle 2202 may be an example of vehicle 2 depicted and described in conjunction with FIG. 1, vehicle 100 depicted and described in conjunction with FIG. 2, or some combination thereof.

Ego vehicle 2202 can perform operation 2102 to display, on a GUI of ego vehicle 2202, at least one of: (a) values of a collaborative vehicle tampering deterrence metric for a plurality of parking regions overlaid on a map representing a geographic region encompassing the plurality of parking regions; or (b) ego vehicle 2202's potential enhancements to the values of the collaborative vehicle tampering deterrence metric for the plurality of parking regions overlaid on the map.

In some implementations, the collaborative vehicle tampering deterrence metric may be a more specific example of a vehicle tampering deterrence metric. For example, the value of the collaborative vehicle tampering deterrence metric for a respective parking region may quantify at least one of: (i) a number of unique collaborative vehicle tampering deterrence strategies that can be implemented by vehicles parked in the respective parking region; (ii) a number of vehicles capable of contributing to at least one collaborative vehicle tampering deterrence strategy in the respective parking region; or (iii) resources and capabilities of vehicles parked in the respective parking region which can contribute to at least one collaborative vehicle tampering deterrence strategy. For example, in certain implementations the value of the collaborative vehicle tampering deterrence metric for the respective parking region may comprise a weighted score based on at least one of (i)-(iii) above. In other implementations, the value of the collaborative vehicle tampering deterrence metric for the respective parking region may comprise a categorical or numerical classification based on at least one of (i)-(iii) above.

As alluded to above, FIG. 22B depicts an illustrative example of what can be displayed on the GUI of ego vehicle 2202 to illustrate the values of the collaborative vehicle tampering deterrence metric for parking regions 2206(a)-(n). In the specific example of FIG. 22B, numerical symbols overlaid on locations of respective parking regions on a map are used to illustrate the values of the collaborative vehicle tampering deterrence metric for the respective parking regions. For example, a “1” is overlaid on the location of parking region 2206(a) on the map. By contrast, a “2” is overlaid on the location of parking region 2206(i) on the map, and a “3” is overlaid on the location of parking region 2206(g) on the map. These numerical symbols may indicate that among these three parking regions, parking region 2206(g) has the highest value of the collaborative vehicle tampering deterrence metric, parking region 2206(i) has the second highest value of the collaborative vehicle tampering deterrence metric, and parking region 2206(a) has the lowest value of the collaborative vehicle tampering deterrence metric.

While in the specific example of FIG. 22B, the values of the collaborative vehicle tampering deterrence metric are illustrated using numerical symbols, in other implementations other types of visual indicators may be used to illustrate relative values of the collaborative vehicle tampering deterrence metric. For example, certain implementations may use other types of symbols, color-coding, brightness or color contrasts, pattern or texture contrasts, or some combination thereof.

In some implementations, the values of the collaborative vehicle tampering deterrence metric for parking regions 2206(a)-(n) visualized in FIG. 22B may correspond to values that do not include ego vehicle 2202's potential enhancements/contributions.

By contrast (and as described above), FIG. 22C provides an illustrative example of what can be displayed on the GUI of ego vehicle 2202 to illustrate ego vehicle 2202's potential enhancements/contributions to the values of the collaborative vehicle tampering deterrence metric. As depicted, an indicator box showing an enhancement in the value of the collaborative vehicle tampering deterrence metric from “1” to “3” is overlaid on parking region 2206(a)'s location on a map. Similarly, an indicator box showing no enhancement is overlaid on parking region 2206(b)'s location on the map. Indicator boxes illustrating enhancements (or lack thereof) for the values of the collaborative vehicle tampering deterrence metric for the other parking regions are similarly overlaid on their respective locations on the map.

As may be appreciated, different visual indicators may be used to illustrate enhancements (or lack thereof) for the values of the collaborative vehicle tampering deterrence metric for parking regions 2206(a)-(n). For example, color-coding (e.g., a color scale that quantifies an amount of enhancement) may be used to illustrate enhancements (or lack thereof) while numerical (or categorical) symbols can be used to illustrate the values of the collaborative vehicle tampering deterrence metric resulting from ego vehicle 2202's enhancements (or lack thereof). In other implementations, values of the collaborative vehicle tampering deterrence metric before and after ego vehicle 2202's potential enhancements may be shown (or flashed) in sequence to illustrate the enhancements. For example, a “3” may be flashed after a “1” over the location of parking region 2206(a) on the map to illustrate how ego vehicle 2202 could enhance the value of the collaborative vehicle tampering deterrence metric for parking region 2206(a).

As alluded to above, in certain implementations additional visual indicators related to incentives for parking in particular parking regions may be displayed as well. For example, narrative or symbolic information may be overlaid over the location of parking region 2206(a) indicating that ego vehicle 2202 (or more particularly, the owner of ego vehicle 2202) may receive a reduction in parking fees if ego vehicle selects and ultimately parks in parking region 2206 (a).

In sum, the visual information displayed on the GUI of ego vehicle 2202 may help an occupant of ego vehicle 2202 understand and appreciate the enhancements/contributions that ego vehicle 2202 can make. The visual information may also inform the occupant of incentives that ego vehicle 2202 can receive by selecting and ultimately parking in a particular parking region (i.e., as a quid pro quo for enhancing the collaborative vehicle tampering deterrence capabilities at the particular parking region). Based on this information, the occupant may: (a) decide which parking region to park in; (b) request more information on how ego vehicle 2202 could enhance collaborative deterrence capabilities at respective parking regions; or (c) some combination thereof.

Accordingly, responsive to a user input selecting a first parking region of the plurality of parking regions, ego vehicle 2202 can perform operation 2104 to at least one of: (1) navigate ego vehicle 2202 to the first parking region; or (2) display, on a GUI of ego vehicle 2202, an audio-visual recreation of at least one collaborative vehicle tampering deterrence strategy that ego vehicle 2202 would enable by parking in the first parking region. As described above, in some implementations this user selection may be made on the GUI via a touch-screen interface.

For example, responsive to a user input selecting parking region 2206(a), ego vehicle 2202 can navigate ego vehicle 2202 to parking region 2206(a) by at least one of: (i) autonomously controlling ego vehicle 2202 to parking region 2206(a); or (ii) displaying a navigation route to parking region 2206(a) on the GUI of ego vehicle 2202.

Alternative or in addition to navigating ego vehicle 2202 to parking region 2206(a), ego vehicle 2202 can display, on the GUI, an audio-visual recreation of at least one collaborative vehicle tampering deterrence strategy that ego vehicle 2202 would enable by parking in parking region 2206(a). Various examples of collaborative vehicle tampering deterrence strategies have been described above. Consistent with these examples, in various implementations the audio-visual recreations of collaborative vehicle tampering deterrence strategies may comprise at least one of: (i) an audio-visual recreation of multiple vehicles in parking region 2206(a) sounding alarms in a sequence or pattern; (ii) an audio-visual recreation of one vehicle in parking region 2206(a) displaying video of suspicious activity in parking region 2206(a) while another vehicle in parking region 2206(a) plays audio of the suspicious activity; (iii) an audio-visual recreation of multiple vehicles in parking region 2206(a) moving autonomously in a pattern to deter suspicious activity; (iv) an audio-visual recreation of one vehicle in parking region 2206(a) illuminating parking region 2206(a) while one or more other vehicles in parking region 2206(a) move autonomously to deter suspicious activity; (v) an audio-visual recreation of one or more vehicles in parking region 2206(a) recording suspicious activity and transmitting the recorded suspicious activity to another vehicle in parking region 2206(a) which further analyzes the recorded suspicious activity (e.g., to determine another collaborative vehicle tampering deterrence strategy to implement); or (vi) an audio-visual recreation of multiple vehicles sequentially recording, based on their relative positions within parking region 2206(a), a suspicious individual as the suspicious individual moves through parking region 2206(a). As may be appreciated, the audio-visual recreations (i)-(vi) above are merely illustrative examples, and audio-visual recreations of other collaborative vehicle tampering deterrence strategies may be displayed on the GUI of ego vehicle 2202.

The above-referenced audio-visual recreations may take various forms. For example, in some implementations the audio-visual recreations may be purely visual, while in other implementations audio (e.g., siren sounds, audio of a suspicious individual being played back by a vehicle to confuse or disorient the suspicious individual, etc.) may be incorporated as well. The visual aspects of the audio-visual recreations may include still image frames, sequences of still image frames, or video (or video-like) recreations.

An example audio-visual recreation of a collaborative vehicle tampering deterrence strategy is depicted in FIG. 22D. As depicted, the audio-visual recreation may be displayed on a GUI 2202(a) of ego vehicle 2202. The audio-visual recreation may comprise a video or sequence of images that illustrate a collaborative vehicle tampering deterrence strategy that involves multiple vehicles moving in a pattern (e.g., as controlled by parking assist systems of the vehicles) to confuse or disorient two individuals who are suspected of vehicle tampering. In some of such implementations, a visual representation of ego vehicle 2202 may be depicted in such an audio-visual recreation.

As may be appreciated, the audio-visual recreations described above can help an occupant of ego vehicle 2202 further understand and appreciate how ego vehicle 2202 could enhance collaborative vehicle tampering deterrence strategies in parking region 2206(a), which may further inform the occupant's decision to park ego vehicle 2202 in parking region 2206(a).

After parking in the first parking region, ego vehicle 2202 can perform operation 2106 to participate in a collaborative vehicle tampering deterrence strategy to deter suspicious activity in the first parking region.

For example, responsive to a detection of suspicious activity in parking region 2206(a), ego vehicle 2202 may participate in a collaborative vehicle tampering deterrence strategy to deter the suspicious activity.

As described above, non-limiting examples of collaborative vehicle tampering deterrence strategies that ego vehicle 2202 may participate in may include: (i) a collaborative vehicle tampering deterrence strategy involving multiple vehicles in parking region 2206(a) sounding alarms in a sequence or pattern; (ii) a collaborative vehicle tampering deterrence strategy involving one vehicle displaying video of suspicious activity in parking region 2206(a) while another vehicle in parking region 2206(a) plays audio of the suspicious activity; (iii) a collaborative vehicle tampering deterrence strategy involving multiple vehicles in parking region 2206(a) moving autonomously in a pattern to deter suspicious activity; (iv) a collaborative vehicle tampering deterrence strategy involving one vehicle in parking region 2206(a) illuminating parking region 2206(a) while one or more other vehicles in parking region 2206(a) move autonomously to deter suspicious activity; (v) a collaborative vehicle tampering deterrence strategy involving one or more vehicles in parking region 2206(a) recording suspicious activity and transmitting the recorded suspicious activity to another vehicle in parking region 2206(a) which further analyzes the recorded suspicious activity (e.g., to determine another collaborative vehicle tampering deterrence strategy to implement); or (vi) a collaborative vehicle tampering deterrence strategy involving multiple vehicles sequentially recording, based on their relative positions within parking region 2206(a), a suspicious individual as the suspicious individual moves through parking region 2206(a).

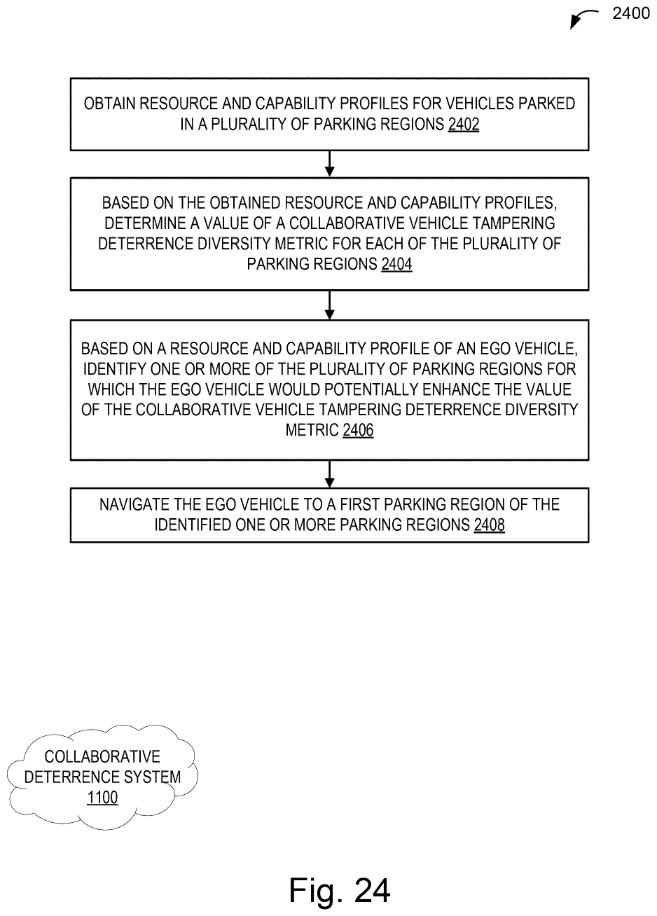

Like FIGS. 19-22, FIGS. 24-28 illustrate example systems and methods for enhancing vehicle security for a geographic region through intelligent and proactive parking selection guidance. More particularly, FIGS. 24-28 illustrate example systems and methods for enhancing the diversity of collaborative vehicle tampering deterrence strategies that can be implemented in a geographic region through intelligent and proactive parking selection guidance.

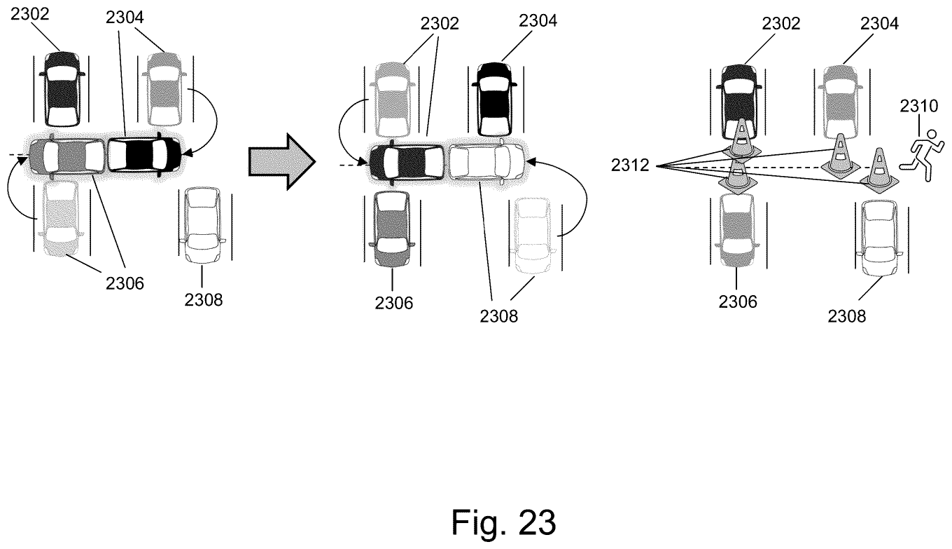

While vehicles are becoming increasingly connected and intelligent, intruders are also becoming more sophisticated. As intruders recognize repeating patterns in vehicle tampering deterrence strategies, they can develop effective countermeasures to bypass them. For instance, intruders may tamper with a vehicle's electronic systems to disable alarms or stop video recording. Intruders might also exploit vulnerabilities in smart key protocols to deactivate security features. Even in cases where vehicles coordinate deterrence actions —such as moving in a synchronized pattern —intruders can hinder these responses by placing physical obstructions, like traffic cones or decoy human figures, to block vehicle movement and neutralize the deterrence actions. FIG. 23 illustrates an example of such a hindrance. As depicted, an intruder 2310 may place traffic cones 2312 behind vehicles 2302-2308 to block vehicles 2302-2308 from moving in a coordinated pattern.

Related to above, certain environments—such as specific parking regions—may benefit from specific strategies to more effectively deter suspicious activity. For example, intruders may attempt to lift a vehicle to steal its catalytic converter. An effective deterrence strategy in such cases may be for a group of vehicles in a parking region to move in a coordinated pattern, creating dynamic deterrence through motion. However, it may be the case that only one vehicle in the parking region is capable of autonomously moving in a predetermined pattern. This may be insufficient to implement the collaborative vehicle tampering deterrence strategy that involves multiple vehicles moving in a coordinated pattern. Accordingly, an additional vehicle that is capable of autonomously moving in a predetermined pattern may be required to implement the strategy effectively.

Against this backdrop, FIGS. 24-28 illustrate example systems and methods for enhancing the diversity of collaborative vehicle tampering deterrence strategies that can be implemented in a geographic region through intelligent and proactive parking selection guidance. In some implementations this may involve: (1) determining at least one unmet resource and capability need that would prevent a group of vehicles currently parked in a respective parking region from being able to execute a particular collaborative vehicle tampering deterrence strategy; (2) determining an ego vehicle meets the at least one unmet resource and capability need; and (3) navigating the ego vehicle to the respective parking region.

As alluded to above, by enhancing the diversity of collaborative vehicle tampering deterrence strategies that can be implemented in a geographic region, the presently disclosed systems and methods can make it more difficult for intruders to recognize patterns in collaborative vehicle tampering deterrence strategies and develop countermeasures. Relatedly, such an enhancement in diversity can increase the availability/feasibility of particularized collaborative vehicle tampering deterrence strategies which are suited for deterring particular tampering and intrusion actions.

FIG. 24 illustrates an example method 2400 that may be performed by collaborative deterrence system 1100 to navigate an ego vehicle to a parking region to enhance the diversity of collaborative vehicle tampering deterrence strategies that can be implemented in the parking region, in accordance with various embodiments of the presently disclosed technology.

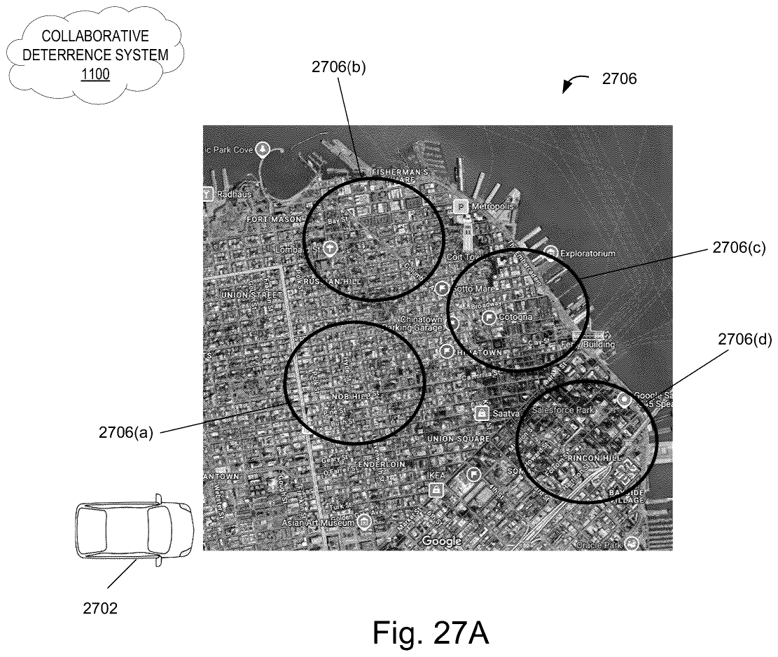

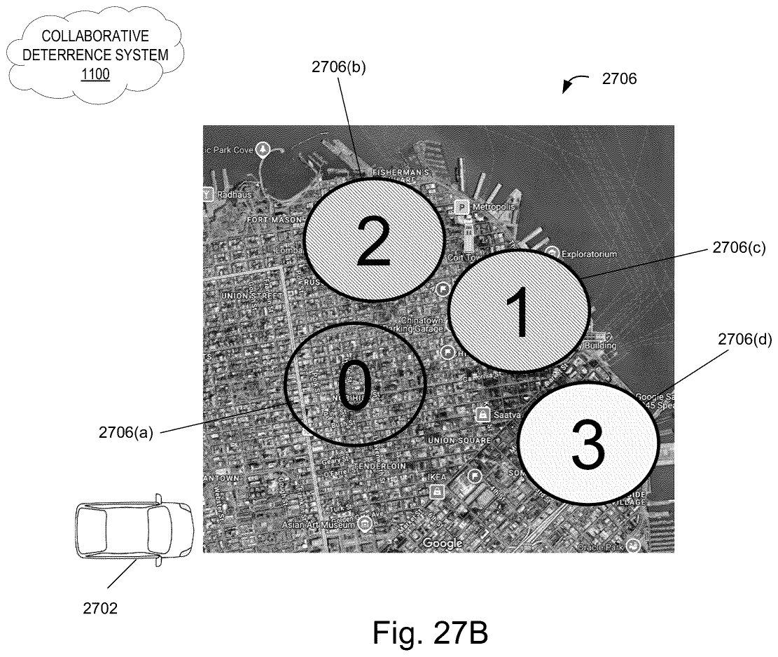

Collaborative deterrence system 1100 can perform operation 2402 to obtain resource and capability profiles for vehicles parked in a plurality of parking regions. For example, and as depicted in FIGS. 27A-27B, collaborative deterrence system 1100 can obtain resource and capability profiles for vehicles parked in parking regions 2706(a)-(d) within a geographic region 2706. Collaborative deterrence system 1100 can perform this operation in the same/similar manner as described above for operation 1906 of method 1900. As described above, in some implementations obtaining the resource and capability profiles for the vehicles parked in the plurality of parking regions may first involve identifying the plurality of parking regions as parking regions with at least one available parking spot.

Based on the obtained resource and capability profiles, collaborative deterrence system 1100 can perform operation 2404 to determine a value of a collaborative vehicle tampering deterrence diversity metric for each of the plurality of parking regions.

For example, collaborative deterrence system 1100 can determine a value of a collaborative vehicle tampering deterrence diversity metric for each of parking regions 2706(a)-(d).

As described above, the value of the collaborative vehicle tampering deterrence diversity metric for a respective parking region may quantify a diversity of collaborative vehicle tampering deterrence strategies that can be implemented by vehicles parked in the respective parking region. For example, in certain implementations the value of the collaborative vehicle tampering deterrence diversity metric for the respective parking region may quantify at least one of: (i) a number of unique collaborative vehicle tampering deterrence strategies that can be implemented by the vehicles parked in the respective parking region; or (ii) a diversity of resources and capabilities of the vehicles parked in the respective parking region which can contribute to at least one collaborative vehicle tampering deterrence strategy. For example, in certain implementations the value of the collaborative vehicle tampering deterrence diversity metric for the respective parking region may comprise a weighted score based on at least one of (i)-(ii) above. In other implementations, the collaborative vehicle tampering deterrence diversity metric may comprise a categorical or numerical classification based on at least one of (i)-(ii) above.

Based on a resource and capability profile of an ego vehicle, collaborative deterrence system 1100 can perform operation 2406 to identify one or more of the plurality of parking regions for which the ego vehicle would potentially enhance the value of the collaborative vehicle tampering deterrence diversity metric.

For example (and as depicted in FIGS. 27A-27B), based on a resource and capability profile of an ego vehicle 2702, collaborative deterrence system 1100 may identify parking regions 2706(b)-(d) as parking regions for which ego vehicle 2702 would potentially enhance the value of the collaborative vehicle tampering deterrence diversity metric. In other words, collaborative deterrence system 1100 can determine that ego vehicle 2702 would enhance the value of the collaborative vehicle tampering deterrence diversity metric for a respective one of parking regions 2706(b)-(d) if ego vehicle 2702 were to park there.

As described above, the resource and capability profile for ego vehicle 2702 may comprise at least one of: (i) sensor resources of ego vehicle 2702 (e.g., cameras, Lidar, radar, or other sensors); (ii) processing resources of ego vehicle 2702 (e.g., an amount of computing power); (iii) memory resources of ego vehicle 2702 (e.g., an amount of memory storage); (iv) wireless communication resources of ego vehicle 2702 (e.g., V2V Wifi, V2N Wifi, other V2V or V2N communication capabilities, etc.); (v) audio-visual output capabilities of ego vehicle 2702 (e.g., sirens, alarms, lights, visual displays, etc.); or (vi) autonomous driving capabilities of ego vehicle 2702 (e.g., advanced parking assist, L1-L5 autonomy, etc.).

As described above, collaborative deterrence system 1100 can determine ego vehicle 2702's potential enhancements to the values of the collaborative vehicle tampering deterrence diversity metric for the parking regions 2706(a)-(d) in various ways. In some implementations, this may involve determining an amount (if any) by which ego vehicle 2702 would enhance the value of the collaborative vehicle tampering deterrence diversity metric for each of parking regions 2706(a)-(d).

For example, and as depicted in FIG. 22B, collaborative deterrence system 1100 may determine that ego vehicle 2702 would enhance/increase the value of the collaborative vehicle tampering deterrence diversity metric for parking region 2206(b) from “1” to “2”. Similarly, collaborative deterrence system 1100 may determine that ego vehicle 2702 would enhance/increase the value of the collaborative vehicle tampering deterrence diversity metric for parking region 2206(c) from “0” to “1”. Likewise, collaborative deterrence system 1100 may determine that ego vehicle 2702 would enhance/increase the value of the collaborative vehicle tampering deterrence diversity metric for parking region 2206(d) from “1” to “3”. By contrast, collaborative deterrence system 1100 may determine that ego vehicle 2702 would not enhance/increase the value of the collaborative vehicle tampering deterrence diversity metric for parking region 2206(a) from its prior value of “0”.

In the specific example of FIG. 27B where the values of the collaborative vehicle tampering deterrence diversity metric are numerical values, the above-referenced enhancements may correspond with an increase in the numerical values. As may be appreciated however, in implementations where the values of the collaborative vehicle tampering deterrence diversity metric comprise categorical values or other values, the above-referenced enhancements may take different forms. For example, in an implementation where the values of the collaborative vehicle tampering deterrence diversity metric comprise a categorical hierarchy (e.g., “low,” “medium” or “high”), the above-referenced enhancements may take the form of a change in category up the hierarchy (e.g., a change from “low” to “medium,” a change from “low” to “high,” etc.).

In various implementations, ego vehicle 2702 may enhance the values of the collaborative vehicle tampering deterrence diversity metric for different parking regions by different amounts depending on how complementary ego vehicle 2702's resource and capability profile is with the resource and capability profiles of other vehicles parked in the respective parking region. For example, ego vehicle 2702 may enhance the value of the collaborative vehicle tampering deterrence diversity metric for parking region 2706(d) by a greater amount than for parking regions 2206(a)-(c) because ego vehicle 2702 has a more complementary resource and capability profile with the vehicles parked in parking region 2206(d) than with the vehicles parked in parking regions 2206(a)-(c). In various scenarios, the complementary nature of ego vehicle 2702's resource and capability profile may enable the vehicles parked within parking region 2706(d) to perform a greater number or diversity of collaborative vehicle tampering deterrence strategies. In addition or alternative to the foregoing, the complementary nature of ego vehicle 2702's resource and capability profile may enhance the effectiveness of one or more collaborative vehicle tampering deterrence strategies that the vehicles of parking region 2206(d) could perform absent ego vehicle 2702's contributions. For example, the vehicles currently parked in parking regions 2706(d) may already be able to perform a collaborative vehicle tampering deterrence strategy that involves a sequential triggering of alarms by multiple vehicles to follow a suspicious individual as the suspicious individual moves through parking region 2206(d). However, the addition of ego vehicle 2702 may allow such a sequential triggering of alarms to follow the suspicious individual for a longer distance.

Related to above, in some implementations determining ego vehicle 2702's potential enhancement to the value of the collaborative vehicle tampering deterrence diversity metric for a respective parking region may comprise: (a) determining at least one unmet resource and capability need that would prevent the vehicles currently parked in the respective parking region from being able to execute a first collaborative vehicle tampering deterrence strategy; and (b) determining ego vehicle 2702 meets the at least one unmet resource and capability need. For example, two or more vehicle currently parked in parking region 2706(d) may be equipped to perform a collaborative vehicle tampering deterrence strategy that involves multiple vehicles moving autonomously in a coordinated pattern. However, inadequate lighting in parking region 2706(d) may prevent these vehicles from performing this collaborative vehicle tampering deterrence strategy. However, ego vehicle 2702 may have enhanced lighting capabilities that would effectively meet this unmet resource and capability need. Accordingly, collaborative deterrence system 1100 may: (a) determine that a lack of adequate lighting would prevent the vehicles currently parked in parking region 2702(d) from being able to execute the collaborative vehicle tampering deterrence strategy that involves multiple vehicles moving autonomously in a coordinated pattern; and (b) determine that ego vehicle 2702 meets the at least one unmet resource and capability need because of ego vehicle 2702's enhanced lighting capabilities.

Collaborative deterrence system 1100 can perform operation 2408 to navigate the ego vehicle to a first parking region of the identified one or more parking regions.

For example, collaborative deterrence system 1100 can navigate ego vehicle 2702 to parking region 2706(d). In some implementations, this may comprise navigating ego vehicle 2702 to an available parking spot in parking region 2706(d).

In some implementations, navigating ego vehicle 2702 to parking region 2706(d) may comprise autonomously controlling ego vehicle 2702 along a route to parking region 2706(d). In other implementations, navigating ego vehicle 2702 to parking region 2706(d) may comprise displaying a navigation route to parking region 2706(d) on a GUI (e.g., a dashboard screen) of ego vehicle 2702 to guide a driver of ego vehicle 2702.

Collaborative deterrence system 1100 can determine to navigate ego vehicle 2702 to parking region 2706(d) in various ways.

For example, in some implementations collaborative deterrence system 1100 may determine that ego vehicle 2702 would enhance the value of the collaborative vehicle tampering deterrence diversity metric for parking region 2706(d) by the greatest amount among parking regions 2706(a)-(d), and navigate ego vehicle to parking region 2706(d) accordingly. In scenarios where collaborative deterrence system 1100 determines that ego vehicle 2702 would enhance the values of the collaborative vehicle tampering deterrence diversity metric for additional parking regions by the same or similar amounts, collaborative deterrence system 1100 can determine to navigate ego vehicle to parking region 2706(d) because parking region 2706(d) is closer to an anticipated destination of ego vehicle 2702 than these additional parking regions. In addition or alternative to the foregoing, collaborative deterrence system 1100 may determine that parking region 2706(d) would have the lowest value of the collaborative vehicle tampering deterrence diversity metric absent ego vehicle 2702's enhancement, and navigate ego vehicle 2702 to parking region 2706(d) accordingly. In other words, collaborative deterrence system 1100 may determine that parking region 2706(d) is in the greatest need of ego vehicle 2702, and navigate ego vehicle 2702 to parking region 2706(d) accordingly. In scenarios where collaborative deterrence system 1100 determines that additional parking regions have the same or similar needs for ego vehicle 2702, collaborative deterrence system 1100 can determine to navigate ego vehicle to parking region 2706(d) because parking region 2706(d) is closer to the anticipated destination of ego vehicle 2702 than these additional parking regions.

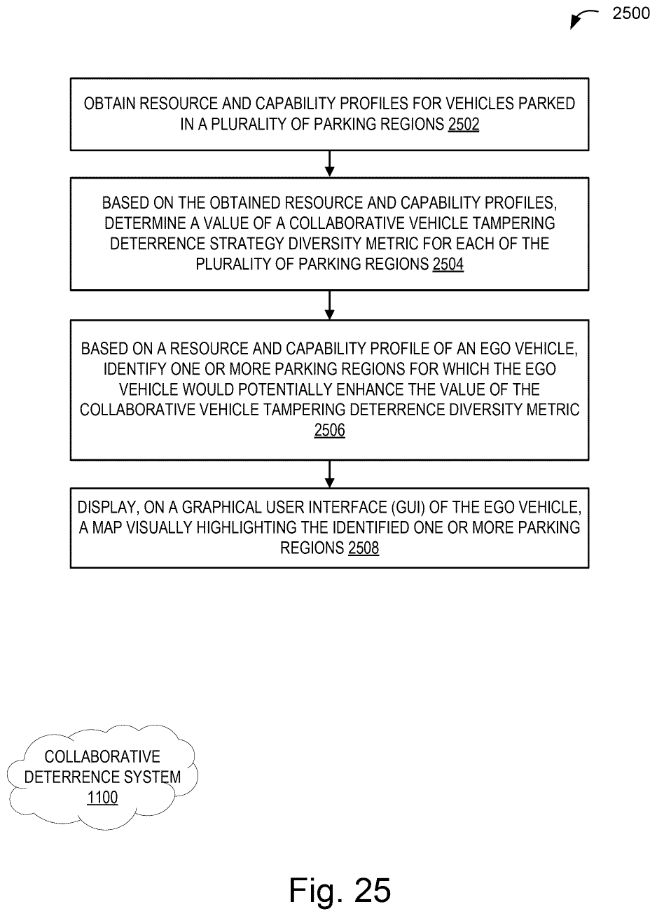

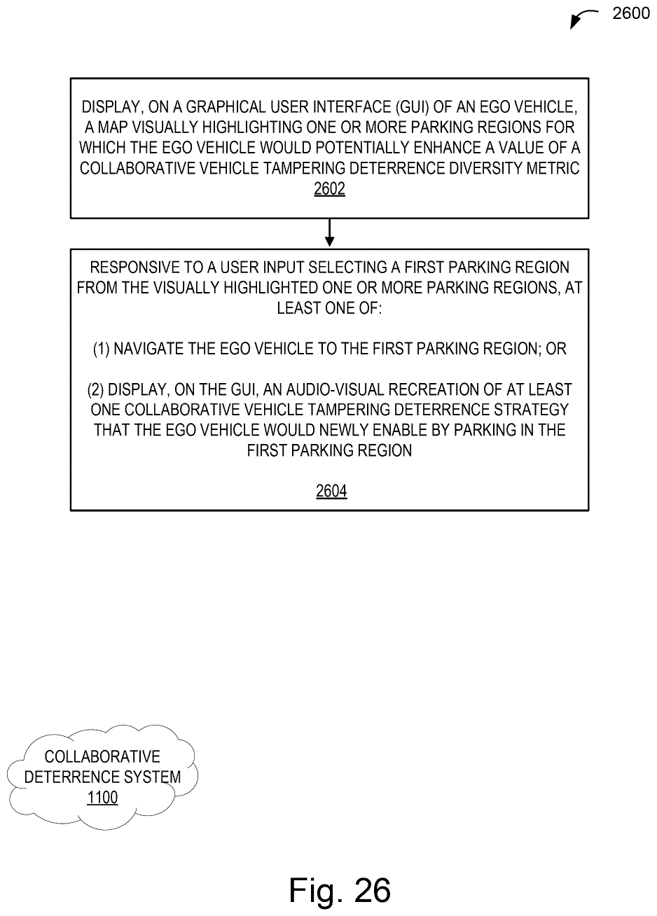

As described in greater detail in conjunction with FIGS. 25 and 26, in some implementations collaborative deterrence system 1100 may navigate ego vehicle 2702 to parking region 2706(d) responsive to an occupant of ego vehicle 2702 selecting parking region 2706(d) (e.g., via a touch-screen GUI of ego vehicle 2702). The occupant may provide this selection after collaborative deterrence system 1100 provides information (e.g., via the touch-screen GUI of ego vehicle 2702) related to at least one of: (i) values of the collaborative vehicle tampering deterrence diversity metric for parking regions 2706(a)-(d) absent ego vehicle 2702's enhancements/contributions; or (ii) ego vehicle 2702's potential enhancements to the values of the collaborative vehicle tampering deterrence diversity metric for these parking regions. Such information may help the occupant understand and appreciate the enhancements/contributions that ego vehicle 2702 can make, and better inform the occupant's decision of where to park ego vehicle 2702.

FIG. 25 illustrates an example method 2500 that may be performed by collaborative deterrence system 1100 to visualize, for an occupant of an ego vehicle, the ego vehicle's potential enhancements to the diversity of collaborative vehicle tampering deterrence capabilities for different parking regions, in accordance with various embodiments of the presently disclosed technology.

Collaborative deterrence system 1100 can perform operation 2502 to obtain resource and capability profiles for vehicles parked in a plurality of parking regions. For example, collaborative deterrence system 1100 can obtain resource and capability profiles for vehicles parked in parking regions 2706(a)-(d) within geographic region 2706. Collaborative deterrence system 1100 can perform operation this operation in the same/similar manner as described above for operation 2402.

Based on the obtained resource and capability profiles, collaborative deterrence system 1100 can perform operation 2504 to determine a value of a collaborative vehicle tampering deterrence diversity metric for each of the plurality of parking regions. For example, collaborative deterrence system 1100 can determine a value of a collaborative vehicle tampering deterrence diversity metric for each of parking regions 2706(a)-(d). Collaborative deterrence system 1100 can perform operation this operation in the same/similar manner as described above for operation 2404.

Based on a resource and capability profile of an ego vehicle, collaborative deterrence system 1100 can perform operation 2506 to identify one or more of the plurality of parking regions for which the ego vehicle would potentially enhance the value of the collaborative vehicle tampering deterrence diversity metric. For example, based on a resource and capability profile of ego vehicle 2702, collaborative deterrence system 1100 may identify parking regions 2706(b)-(d) as parking regions for which ego vehicle 2702 would potentially enhance the value of the collaborative vehicle tampering deterrence diversity metric. In other words, collaborative deterrence system 1100 can determine that ego vehicle 2702 would enhance the value of the collaborative vehicle tampering deterrence diversity metric for a respective one of parking regions 2706(b)-(d) if ego vehicle 2702 were to park there. Collaborative deterrence system 1100 can perform operation this operation in the same/similar manner as described above for operation 2406.

Collaborative deterrence system 1100 can perform operation 2508 to display, on a GUI of the ego vehicle, a map visually highlighting the identified one or more parking regions. For example, collaborative deterrence system 1100 can display, on a GUI of ego vehicle 2702, a map visually highlighting parking regions 2706(b)-(d).

In various implementations, visually highlighting a respective parking region may comprise at least one of: (i) displaying a symbol overlaying the respective parking region on the map (e.g., a numerical symbol corresponding with the value of the collaborative vehicle tampering deterrence diversity metric for the respective parking region); (ii) using color or brightness contrast to visually highlight the first parking region on the map (e.g., where different colors or brightnesses correspond with different values of the collaborative vehicle tampering deterrence diversity metric); (iii) using a pattern or texture contrast to visually highlight the first parking region on the map (e.g., where different patterns or textures correspond with different values of the collaborative vehicle tampering deterrence diversity metric); (iv) displaying, as a symbol overlaying the first parking region on the map, the potentially enhanced value of the collaborative vehicle tampering deterrence diversity metric that would result from the ego vehicle parking in the first parking region (e.g., a numerical symbol corresponding with the potentially enhanced value of the collaborative vehicle tampering deterrence diversity metric); (v) displaying, as one or more symbols overlaying over the first parking region on the map, the potential enhancement in the value of the collaborative vehicle tampering deterrence diversity metric that would result from the ego vehicle parking in the first parking region (e.g., a first numerical symbol corresponding with the old value of the collaborative vehicle tampering deterrence diversity metric and a second numerical symbol corresponding with the new value of the collaborative vehicle tampering deterrence diversity metric); (vi) displaying, as color-coding overlaying over the first parking region on the map, the potentially enhanced value of the collaborative vehicle tampering deterrence diversity metric that would result from the ego vehicle parking in the first parking region (e.g., where different colors correspond with different values of the collaborative vehicle tampering deterrence diversity metric); (vii) displaying, as color-coding overlaying over the first parking region on the map, the potential enhancement in the value of the collaborative vehicle tampering deterrence diversity metric that would result from the ego vehicle parking in the first parking region (e.g., where different colors correspond with different increases in the value of the collaborative vehicle tampering deterrence diversity metric); (viii) using color or brightness contrast to illustrate the potentially enhanced value of the collaborative vehicle tampering deterrence diversity metric that would result from the ego vehicle parking in the first parking region; (ix) using color or brightness contrast to illustrate the potential enhancement in the value of the collaborative vehicle tampering deterrence diversity metric that would result from the ego vehicle parking in the first parking region; (x) using a pattern or texture contrast to illustrate the potentially enhanced value of the collaborative vehicle tampering deterrence diversity metric that would result from the ego vehicle parking in the first parking region; or (xi) using a pattern or texture contrast to the potential enhancement in the value of the collaborative vehicle tampering deterrence diversity metric that would result from the ego vehicle parking in the first parking region.

FIG. 27B illustrates one illustrative example of what can be displayed on the GUI of ego vehicle 2702. As depicted, numerical symbols corresponding with the potentially enhanced values of the collaborative vehicle tampering deterrence diversity metric are overlaid on the locations of parking regions 2702(a)-(d) on a map of geographic region 2706. The “0” overlaying parking region 2702(a) may indicate that the value of the collaborative vehicle tampering deterrence diversity metric for parking region 2702(a) would remain at “0” even if ego vehicle 2702 were to park there. The “2” overlaying parking region 2702(b) may indicate that the value of the collaborative vehicle tampering deterrence diversity metric for parking region 2702(b) would be “2” if ego vehicle 2702 were to park there. The “1” overlaying parking region 2702(c) may indicate that the value of the collaborative vehicle tampering deterrence diversity metric for parking region 2702(c) would be “1” if ego vehicle 2702 were to park there. The “3” overlaying parking region 2702(d) may indicate that the value of the collaborative vehicle tampering deterrence diversity metric for parking region 2702(d) would be “3” if ego vehicle 2702 were to park there.

In the specific example of FIG. 27B, pattern/textures are used to visualize the potential enhancements in the values of the collaborative vehicle tampering deterrence diversity metric for parking regions 2702(a)-(d). As depicted, no pattern is overlayed parking region 2706(a) indicating no enhancement in the value of the collaborative vehicle tampering deterrence diversity metric for parking region 2702(a). A diagonal-striped pattern is overlaid parking regions 2706(b) and 2706(c), indicating an increase by 1 in the values of the collaborative vehicle tampering deterrence diversity metric for parking regions 2706(b) and 2706(c). A horizontal-striped pattern is overlaid parking region 2706(d), indicating an increase by 2 in the value of the collaborative vehicle tampering deterrence diversity metric for parking regions 2706(d). As may be appreciated, different visual indicators and schemes may be used depending on implementation.

FIG. 26 illustrates an example method 2600 that may be performed by collaborative deterrence system 1100 to display audio-visual recreations of collaborative vehicle tampering deterrence strategies that an ego vehicle would enable in a parking region, in accordance with various embodiments of the presently disclosed technology.

Collaborative deterrence system 1100 can perform operation 2602 to display, on a GUI of an ego vehicle, a map visually highlighting one or more parking regions for which the ego vehicle would potentially enhance a value of a collaborative vehicle tampering deterrence diversity metric.

For example, collaborative deterrence system 1100 can display, on a GUI of ego vehicle 2702, a map visually highlighting one or more of parking regions 2706(a)-(d) for which ego vehicle 2702 would potentially enhance a value of a collaborative vehicle tampering deterrence diversity metric. Consistent with the example depicted in FIG. 27B, the visually highlighted parking regions may be parking regions 2706(b)-(d). Collaborative deterrence system 1100 can perform this operation in the same/similar manner as operation 2508 above.

Responsive to a user input selecting a first parking region from the visually highlighted one or more parking regions, collaborative deterrence system 1100 can perform operation 2604 to at least one of: (1) navigate the ego vehicle to the first parking region; or (2) display, on the GUI of the ego vehicle, an audio-visual recreation of at least one collaborative vehicle tampering deterrence strategy that the ego vehicle would newly enable by parking in the first parking region. As described above, in some implementations this user selection may be made on the GUI via a touch-screen interface.

For example, responsive to a user input selecting parking region 2706(d), collaborative deterrence system 1100 can navigate ego vehicle 2702 to parking region 2706(d) by at least one of: (i) autonomously controlling ego vehicle 2702 to parking region 2706(d); or (ii) displaying a navigation route to parking region 2706(d) on the GUI of ego vehicle 2702.

Alternative or in addition to navigating ego vehicle 2702 to parking region 2706(d), ego vehicle 2702 can display, on the GUI of ego vehicle 2702, an audio-visual recreation of at least one collaborative vehicle tampering deterrence strategy that ego vehicle 2702 would enable by parking in parking region 2706(d). Various examples of collaborative vehicle tampering deterrence strategies have been described above. Consistent with these examples, in various implementations the audio-visual recreations of collaborative vehicle tampering deterrence strategies may comprise at least one of: (i) an audio-visual recreation of multiple vehicles in parking region 2706(d) sounding alarms in a sequence or pattern; (ii) an audio-visual recreation of one vehicle in parking region 2706(d) displaying video of suspicious activity in parking region 2706(d) while another vehicle in parking region 2706(d) plays audio of the suspicious activity; (iii) an audio-visual recreation of multiple vehicles in parking region 2706(d) moving autonomously in a pattern to deter suspicious activity; (iv) an audio-visual recreation of one vehicle in parking region 2706(d) illuminating parking region 2706(d) while one or more other vehicles in parking region 2706(d) move autonomously to deter suspicious activity; (v) an audio-visual recreation of one or more vehicles in parking region 2706(d) recording suspicious activity and transmitting the recorded suspicious activity to another vehicle in parking region 2706(d) which further analyzes the recorded suspicious activity (e.g., to determine another collaborative vehicle tampering deterrence strategy to implement); or (vi) an audio-visual recreation of multiple vehicles sequentially recording, based on their relative positions within parking region 2706(d), a suspicious individual as the suspicious individual moves through parking region 2706(d). As may be appreciated, the audio-visual recreations (i)-(vi) above are merely illustrative examples, and audio-visual recreations of other collaborative vehicle tampering deterrence strategies may be displayed on the GUI of ego vehicle 2702.

The above-referenced audio-visual recreations may take various forms. For example, in some implementations the audio-visual recreations may be purely visual, while in other implementations audio (e.g., siren sounds, audio of a suspicious individual being played back by a vehicle to confuse or disorient the suspicious individual, etc.) may be incorporated as well. The visual aspects of the audio-visual recreations may include still image frames, sequences of still image frames, or video (or video-like) recreations.

As may be appreciated, the audio-visual recreations described above can help an occupant of ego vehicle 2702 further understand and appreciate how ego vehicle 2702 could enhance collaborative vehicle tampering deterrence strategy diversity in parking region 2706(d), which may further inform the occupant's decision to park ego vehicle 2702 in parking region 2706(d).

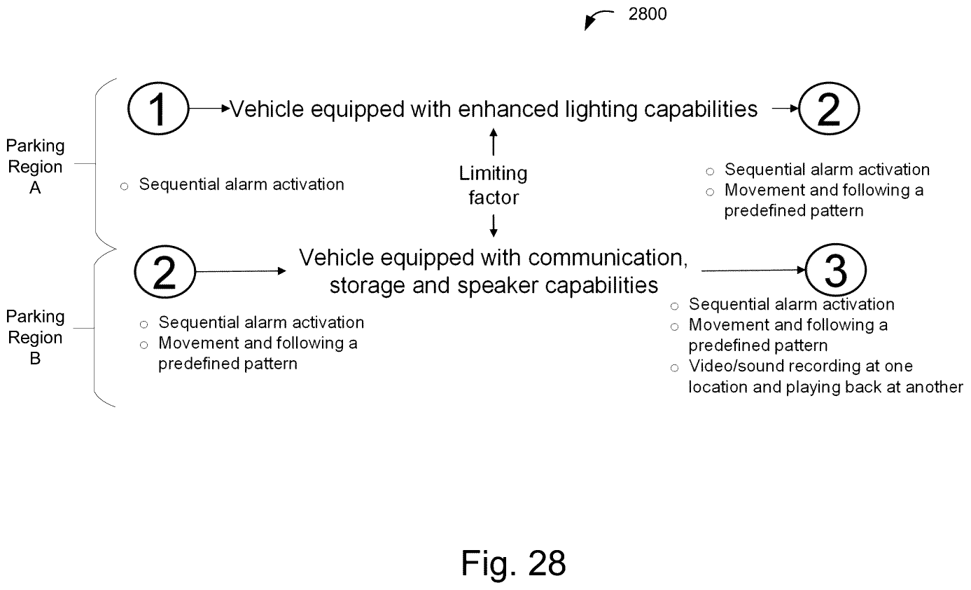

FIG. 28 depicts an example flowchart 2800 illustrating how an addition of an ego vehicle with a particular resource and capability profile can enhance a value of a collaborative vehicle tampering deterrence strategy diversity metric for a parking region, in accordance with various embodiments of the presently disclosed technology.

As depicted, the value of a collaborative vehicle tampering deterrence strategy diversity metric for a parking region A may be “1” as the vehicles currently parking in parking region A may be able to implement a first collaborative vehicle tampering deterrence strategy that involves sounding alarms in a sequence.

However, the addition of an ego vehicle that has enhanced lighting capabilities may enhance the value of the collaborative vehicle tampering deterrence strategy diversity metric to a “2” by enabling the vehicles parked in parking region A to perform a second collaborative deterrence strategy that involves multiple vehicles moving in a pre-defined pattern. Here, inadequate lighting in parking region A may have prevented the vehicles currently parked in parking region A from performing this second collaborative vehicle tampering deterrence strategy. However, the addition of the ego vehicle with enhanced lighting capabilities may meet this unmet resource and capability need, and enhance the value of the collaborative vehicle tampering deterrence strategy diversity metric for parking region A accordingly.

As depicted, the value of the collaborative vehicle tampering deterrence strategy diversity metric for a parking region B may be “2” as the vehicles currently parking in parking region B may be able to implement: (1) the first collaborative vehicle tampering deterrence strategy that involves sounding alarms in a sequence; and (2) the second collaborative deterrence strategy that involves multiple vehicles moving in a pre-defined pattern.

However, the addition of an ego vehicle that has enhanced communication and storage resources, along with enhanced speaker capabilities, may enhance the value of the collaborative vehicle tampering deterrence strategy diversity metric to a “3” by enabling the vehicles parked in parking region B to perform a third collaborative deterrence strategy that involves one vehicle recording video or sound at one location and a second vehicle playing back the video or sound using a speaker or display. Here, a lack of communication and storage resources, and/or a lack of speaker capabilities, may have prevented the vehicles currently parked in parking region B from performing this third collaborative vehicle tampering deterrence strategy. However, the addition of the ego vehicle may meet these unmet resource and capability needs, and enhance the value of the collaborative vehicle tampering deterrence strategy diversity metric for parking region B accordingly.

However, the addition of an ego vehicle that has enhanced lighting capabilities may enhance the value of the collaborative vehicle tampering deterrence strategy diversity metric to a “2” by enabling the vehicles parked in parking region A to perform a new collaborative deterrence strategy that involves multiple vehicles moving in a pre-defined pattern. Here, inadequate lighting in parking region A may have prevented the vehicle currently parked in parking region A from performing this collaborative vehicle tampering deterrence strategy. However, the addition of the ego vehicle with enhanced lighting capabilities may meet this unmet resource and capability need, and enhance the value of the collaborative vehicle tampering deterrence strategy diversity metric accordingly.

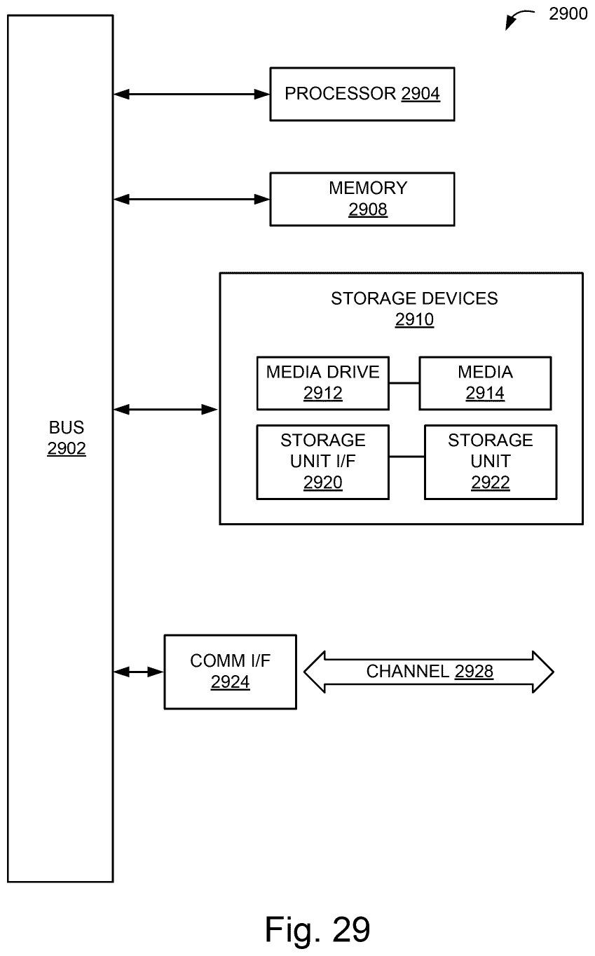

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 29. Various embodiments are described in terms of this example-computing component 2900. After reading this description, it will become apparent to a person skilled in the relevant art how to implement the application using other computing components or architectures.

Referring now to FIG. 29, computing component 2900 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 2900 might also represent computing capabilities embedded within or otherwise available to a given device. For example, a computing component might be found in other electronic devices such as, for example, portable computing devices, and other electronic devices that might include some form of processing capability.

Computing component 2900 might include, for example, one or more processors, controllers, control components, or other processing devices. This can include a processor, and/or any one or more of the components. Processor 2904 might be implemented using a general-purpose or special-purpose processing engine such as, for example, a microprocessor, controller, or other control logic. Processor 2904 may be connected to a bus 2902. However, any communication medium can be used to facilitate interaction with other components of computing component 2900 or to communicate externally.

Computing component 2900 might also include one or more memory components, simply referred to herein as main memory 2908. For example, random access memory (RAM) or other dynamic memory, might be used for storing information and instructions to be executed by processor 2904. Main memory 2908 might also be used for storing temporary variables or other intermediate information during execution of instructions to be executed by processor 2904. Computing component 2900 might likewise include a read only memory (“ROM”) or other static storage device coupled to bus 2902 for storing static information and instructions for processor 2904.

The computing component 2900 might also include one or more various forms of information storage mechanism 1290, which might include, for example, a media drive 2912 and a storage unit interface 2920. The media drive 2912 might include a drive or other mechanism to support fixed or removable storage media 2914. For example, a hard disk drive, a solid-state drive, a magnetic tape drive, an optical drive, a compact disc (CD) or digital video disc (DVD) drive (R or RW), or other removable or fixed media drive might be provided. Storage media 2914 might include, for example, a hard disk, an integrated circuit assembly, magnetic tape, cartridge, optical disk, a CD or DVD. Storage media 2914 may be any other fixed or removable medium that is read by, written to or accessed by media drive 2912. As these examples illustrate, the storage media 2914 can include a computer usable storage medium having stored therein computer software or data.

In alternative embodiments, information storage mechanism 1290 might include other similar instrumentalities for allowing computer programs or other instructions or data to be loaded into computing component 2900. Such instrumentalities might include, for example, a fixed or removable storage unit 2922 and an interface 2920. Examples of such storage units 2922 and interfaces 2920 can include a program cartridge and cartridge interface, a removable memory (for example, a flash memory or other removable memory component) and memory slot. Other examples may include a PCMCIA slot and card, and other fixed or removable storage units 2922 and interfaces 2920 that allow software and data to be transferred from storage unit 2922 to computing component 2900.

Computing component 2900 might also include a communications interface 2924. Communications interface 2924 might be used to allow software and data to be transferred between computing component 2900 and external devices. Examples of communications interface 2924 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 2924 may be carried on signals, which can be electronic, electromagnetic (which includes optical) or other signals capable of being exchanged by a given communications interface 2924. These signals might be provided to communications interface 2924 via a channel 2928. Channel 2928 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 2908, storage unit 2920, media 2914, and channel 2928. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 2900 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Reference to A “and” B may be construed to also encompass the scenario of A “or” B. Reference to A “or” B may be construed to also encompass the scenario of A “and” B. Any reference to a “threshold” or “sufficiency” may be construed to encompass any applicable value or degree. For example, a threshold level, similarity or degree thereof may be construed to include any values such as 99 percent, 98 percent, 95 percent, 90 percent, 80 percent, 75 percent, or any other value therebetween, or any ranges therebetween. Additionally or alternatively, a threshold similarity or degree may be construed as qualitatively satisfying some condition, such as presence of one or more common features. Any reference to sufficiently similar may also be construed to encompass same or similar meanings as satisfying a threshold.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
obtaining resource and capability profiles of vehicles parked in a plurality of parking regions;
based on the obtained resource and capability profiles, determining a value of a vehicle tampering deterrence metric for each of the plurality of parking regions; and
based on the values of the vehicle tampering deterrence metric for the plurality of parking regions, navigating an ego vehicle to a first parking region of the plurality of parking regions.

2. The method of claim 1, wherein navigating the ego vehicle to the first parking region comprises:
displaying, on a graphical user interface (GUI) of the ego vehicle, a navigation route to the first parking region.

3. The method of claim 1, wherein navigating the ego vehicle to the first parking region comprises:
autonomously controlling the ego vehicle to the first parking region.

4. The method of claim 1, further comprising:
based on a resource and capability profile of the ego vehicle, determining the ego vehicle's potential enhancements to the values of the vehicle tampering deterrence metric for the plurality of parking regions;
wherein navigating the ego vehicle to the first parking region is based on the ego vehicle's potential enhancements to the values of the vehicle tampering deterrence metric for the plurality of parking regions.

5. The method of claim 1, further comprising:
displaying, on a GUI of the ego vehicle, the values of the vehicle tampering deterrence metric for the plurality of parking regions overlaid on a map representing a geographic region encompassing the plurality of parking regions.

6. The method of claim 5, wherein navigating the ego vehicle to the first parking region is responsive to an occupant of the ego vehicle selecting the first parking region on the GUI displaying the values of the vehicle tampering deterrence metric for the plurality of parking regions.

7. The method of claim 5, further comprising:
based on a resource and capability profile of the ego vehicle, determining the ego vehicle's potential enhancements to the values of the vehicle tampering deterrence metric for the plurality of parking regions; and
displaying the enhancements on the GUI.

8. The method of claim 7, wherein navigating the ego vehicle to the first parking region is responsive to an occupant of the ego vehicle selecting the first parking region on the GUI displaying the enhancements.

9. The method of claim 1, further comprising:
displaying, on a GUI of the ego vehicle, an audio-visual recreation of at least one collaborative vehicle tampering deterrence strategy that the ego vehicle would enable by parking in the first parking region.

10. The method of claim 9, wherein the audio-visual recreation of the at least one collaborative vehicle tampering deterrence strategy comprises at least one of:
an audio-visual recreation of multiple vehicles in the first parking region sounding alarms in a sequence;
an audio-visual recreation of one vehicle in the first parking region displaying video of suspicious activity in the first parking region while another vehicle in the first parking region plays audio of the suspicious activity;
an audio-visual recreation of multiple vehicles in the first parking region moving autonomously in a pattern to deter the suspicious activity;
an audio-visual recreation of one vehicle in the first parking region illuminating the first parking region while one or more other vehicles in the first parking region move autonomously to the suspicious activity;
an audio-visual recreation of one or more vehicles in the first parking region recording the suspicious activity and transmitting the recorded suspicious activity to another vehicle in the first parking region which analyzes the recorded suspicious activity to determine a collaborative vehicle tampering deterrence strategy; or
an audio-visual recreation of multiple vehicles sequentially recording, based on their relative positions within the first parking region, a suspicious individual as the suspicious individual moves through the first parking region.

11. The method of claim 9, wherein a respective audio-visual recreation depicts a visual representation of the ego vehicle participating in the respective audio-visual recreation.

12. The method of claim 1, wherein the resource and capability profile for a respective vehicle comprises at least one of:
sensor resources of the respective vehicle;
processing resources of the respective vehicle;
memory resources of the respective vehicle;
wireless communication resources of the respective vehicle;
audio-visual output capabilities of the respective vehicle; or
autonomous driving capabilities of the respective vehicle.

13. The method of claim 1, further comprising:
identifying the plurality of parking regions as parking regions with at least one available parking spot.

14. The method of claim 1, wherein the value of the vehicle tampering deterrence metric for a respective parking region quantifies at least one of:
a number of vehicles with vehicle tampering deterrence features in the respective parking region;
a number of vehicles capable of contributing to at least one collaborative vehicle tampering deterrence strategy in the respective parking region;
a number of unique collaborative vehicle tampering deterrence strategies that can be implemented by vehicles parked in the respective parking region; or
resources and capabilities of vehicles parked in the respective parking region which can contribute to at least one collaborative vehicle tampering deterrence strategy.

15. The method of claim 1, wherein the first parking region comprises a parking lot or a region of the parking lot.

16. An ego vehicle comprising:
a graphical user interface (GUI);
one or more processors; and
memory storing machine-readable instructions that, when executed by the one or more processors, cause the ego vehicle to:
display, on the GUI, at least one of:
values of a collaborative vehicle tampering deterrence strategy metric for a plurality of parking regions overlaid on a map representing a geographic region encompassing the plurality of parking regions; or
the ego vehicle's potential enhancements to the values of the collaborative vehicle tampering deterrence strategy metric for the plurality of parking regions; and
responsive to a user input selecting a first parking region of the plurality of parking regions, navigate the ego vehicle to the first parking region.

17. The ego vehicle of claim 16, wherein the user input comprises an occupant of the vehicle touching the GUI proximate a region of the GUI which displays the first parking region on the map.

18. The ego vehicle of claim 16, wherein the machine-readable instructions comprise further instructions that, when executed by the one or more processors, cause the ego vehicle to:
after parking in the first parking region, participate in a collaborative vehicle tampering deterrence strategy to deter suspicious activity in the first parking region.

19. A system comprising:
one or more processors; and
memory storing machine-readable instructions that, when executed by the one or more processors, cause the system to:
obtain resource and capability profiles of vehicles parked in a plurality of parking regions;
based on the obtained resource and capability profiles, determine values of a vehicle tampering deterrence metric for each of the plurality of parking regions;
based on a resource and capability profile of an ego vehicle, determine the ego vehicle's potential enhancements to the values of the vehicle tampering deterrence metric for the plurality of parking regions; and
display, on a graphical user interface (GUI) of the ego vehicle, the determined enhancements overlaid on a map of a geographic region encompassing the plurality of parking regions.

20. The system of claim 19, wherein the machine-readable instructions comprise further instructions that, when executed by the one or more processors, cause the system to:
display, on the GUI, a navigation route to a first parking region of the plurality of parking regions.
